(19) United States
(12) Patent Application Publication
(10) Pub. No.: US 2024/0096234 A1
(43) Pub. Date: Mar. 21, 2024

(54) SYSTEM AND METHODS FOR USER FEEDBACK ON RECEIVING A SIMULATED PHISHING MESSAGE

(71) Applicant: KnowBe4, Inc., Clearwater, FL (US)

(72) Inventor: Katie Brennan, Clearwater, FL (US)

(73) Assignee: KnowBe4, Inc., Clearwater, FL (US)

(21) Appl. No.: 18/370,066

(22) Filed: Sep. 19, 2023

Related U.S. Application Data
(60) Provisional application No. 63/408,589, filed on Sep. 21, 2022.

(51) Int. Cl. G09B 19/00

(52) U.S. Cl. CPC G09B 19/0053

(57) ABSTRACT

Systems and methods are provided for user feedback on receiving simulated phishing communications. A method is described that includes receiving feedback from one or more users that interacted with one or more simulated phishing communications. The feedback identifies one or more reasons that the one or more users interacted with the one or more simulated phishing communications. The method further includes categorizing the feedback into one or more categories of a plurality of categories and collating the categorized feedback into one or more classifications of a plurality of classifications. The method also includes communicating a second one or more simulated phishing communications to one or more users based at least on one of the categorized feedback or the one or more classifications.

### CROSS-REFERENCE TO RELATED APPLICATIONS

This patent application claims the priority and the benefit of U.S. Provisional application 63/408,589, titled, “SYSTEMS AND METHODS FOR USER FEEDBACK ON RECEIVING SIMULATED PHISHING COMMUNICATIONS,” and filed Sep. 21, 2022. The contents of all of which are hereby incorporated herein by reference in its entirety for all purposes.

This disclosure relates to security awareness management. In particular, the present disclosure relates to systems and methods for collecting feedback from users about reasons for interacting with simulated phishing communications. The present disclosure further relates to processing the feedback to target more effective security awareness training and template selection for future simulated phishing communications.

### BACKGROUND OF THE DISCLOSURE

Cybersecurity incidents cost companies millions of dollars each year in actual costs and can cause customers to lose trust in an organization. The incidents of cybersecurity attacks and the costs of mitigating the damage are increasing every year. Many organizations use cybersecurity tools such as antivirus, anti-ransomware, anti-phishing, and other quarantine platforms to detect and intercept known cybersecurity attacks. However, new, and unknown security threats involving social engineering may not be readily detectable by such cyber security tools, and the organizations may have to rely on their employees (referred to as users) to recognize such threats. To enable their users to stop or reduce the rate of cybersecurity incidents, the organizations may conduct security awareness training for their users. The organizations may conduct security awareness training through in-house cybersecurity teams or may use third parties which are experts in matters of cybersecurity. The security awareness training may include cybersecurity awareness training, for example, via simulated phishing attacks, computer-based training, and such training programs. Through security awareness training, organizations educate their users on how to detect and report suspected phishing communication, avoid clicking on malicious links, and use applications and websites safely.

### BRIEF SUMMARY OF THE DISCLOSURE

Systems and methods are provided for user feedback on receiving simulated phishing communications. In an example embodiment, a method is described that includes receiving feedback from one or more users that interacted with one or more simulated phishing communications, the feedback identifying one or more reasons that the one or more users interacted with the one or more simulated phishing communications. In some embodiments, the method further includes categorizing the feedback into one or more categories of a plurality of categories and collating the categorized feedback into one or more classifications of a plurality of classifications. In some embodiments, the method includes communicating a second one or more simulated phishing communications to one or more users based at least on one of the categorized feedback or the one or more classifications.

In some embodiments, the method further includes receiving the feedback selected by the one or more users from a predetermined set of responses.

In some embodiments, the method further includes causing a prompt for feedback from the one or more users responsive to the one or more users interacting with the one or more simulated phishing communications.

In some embodiments, the method further includes collating the feedback into one or more classifications based at least on one or more attributes of the one or more users.

In some embodiments, the method further includes identifying, from the feedback, one or more trends in the one or more reasons for the one or more users to interact with the one or more simulated phishing communications.

In some embodiments, the method further includes identifying, from the feedback, one or more insights into why a specific one or more users interact in one or more specific ways to the one or more simulated phishing communications.

In some embodiments, the method further includes creating a benchmark between the one or more users and another one or more users based on the feedback.

In some embodiments, the method further includes associating with the one or more simulated phishing templates metadata identified based on the feedback.

In some embodiments, the method further includes selecting one or more simulated phishing templates specific based at least on the metadata, the second one or more simulated phishing communications using the selected one or more simulated phishing templates.

In some embodiments, the method further includes using the feedback to create one or more simulated phishing templates, the second one or more simulated phishing communications using the created one or more simulated phishing templates.

In some embodiments, the method further includes receiving additional feedback from the one or more users responsive to security awareness training provided to the one or more users.

In another example embodiment, a system is described that includes one or more servers configured to receive feedback from one or more users that interacted with one or more simulated phishing communications, the feedback identifying one or more reasons that the one or more users interacted with the one or more simulated phishing communications. In some embodiments, the one or more servers are configured to categorize the feedback into one or more categories of a plurality of categories and collate the categorized feedback into one or more classifications of a plurality of classifications. In some embodiments, the one or more servers are configured to communicate a second one or more simulated phishing communications to the one or more users based at least on one of the categorized feedback or the one or more classifications.

Other aspects and advantages of the disclosure will become apparent from the following detailed description, taken in conjunction with the accompanying drawings, which illustrate by way of example, the principles of the disclosure.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIG. 1A is a block diagram depicting an embodiment of a network environment comprising client device in communication with server device;

FIG. 1B is a block diagram depicting a could computing environment comprising client device in communication with cloud service providers;

FIG. 1C and FIG. 1D are block diagrams depicting embodiments of computing devices useful in connection with the methods and systems described herein;

FIG. 2 depicts an implementation of some of a server and client architecture of a system for collecting and processing user feedback about reasons for interacting with simulated phishing communications, according to one or more embodiments;

FIG. 3 depicts an example of a user interface configurable to enable a user feedback requester feature by a system administrator as a part of a configuration of a simulated phishing campaign, according to some embodiments;

FIG. 4A illustrates an example of a user's mailbox including a simulated phishing communication received by a user, according to some embodiments;

FIG. 4B illustrates an example of a user feedback request rendered to the user responsive to the user interacting with a simulated phishing communication, according to some embodiments;

FIG. 5A illustrates an example of a user's mailbox including a simulated phishing communication received by a user, according to some embodiments;

FIG. 5B and FIG. 5C illustrate examples of a series of user feedback requests rendered to the user responsive to the user interacting with a simulated phishing communication, according to some embodiments;

FIG. 6A illustrates an example of a user's mailbox including a simulated phishing communication received by a user, according to some embodiments;

FIG. 6B illustrates an example of a user feedback request accompanied by a selectable list of responses rendered to the user responsive to the user interacting with a simulated phishing communication, according to some embodiments;

FIG. 7 illustrates an example of gathering responses to a user feedback request sent via a messaging service to a user device, according to some embodiments;

FIG. 8A illustrates an example of a user's mailbox including a simulated phishing communication received by a user, according to some embodiments;

FIG. 8B illustrates an example of a user feedback request rendered to the user responsive to the user interacting with a simulated phishing communication, according to some embodiments;

FIG. 8C illustrates an example of a follow up user feedback request rendered to the user after receiving the user's initial feedback, according to some embodiments;

FIG. 9A illustrates an example of a user's mailbox including a simulated phishing communication received by a user, according to some embodiments;

FIG. 9B illustrates an example of a landing page that the user is traversed to in response to interacting with the simulated phishing communication, according to some embodiments;

FIG. 9C illustrates an example of a user feedback web form that is presented to the user during security awareness training, according to some embodiments;

FIG. 10 illustrates an example of an interface presented to a system administrator to view information or trends in the reasons for one or more users to interact with one or more simulated phishing communications, according to some embodiments;

FIG. 11 illustrates an example of selecting one or more simulated phishing template categories by a system administrator, according to some embodiments;

FIG. 12 depicts a flowchart for communicating a second one or more simulated phishing communications to one or more users based on categorized feedback provided by users, according to some embodiments; and

FIG. 13 depicts a flowchart for receiving additional feedback from one or more users that interacted with a second one or more simulated phishing communications to one or more users based on categorized feedback provided by users, according to some embodiments.

### DETAILED DESCRIPTION

For purposes of reading the description of the various embodiments below, the following descriptions of the sections of the specifications and their respective contents may be helpful:

Section A describes a network environment and computing environment which may be useful for practicing embodiments described herein.

Section B describes embodiments of systems and methods for collecting feedback from users about reasons for interacting with simulated phishing communications and processing the feedback to target more effective security awareness training and template selection for future simulated phishing communications.

### A. Computing and Network Environment

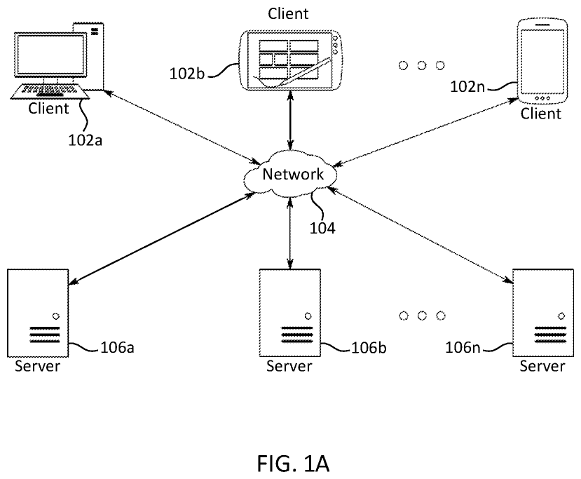

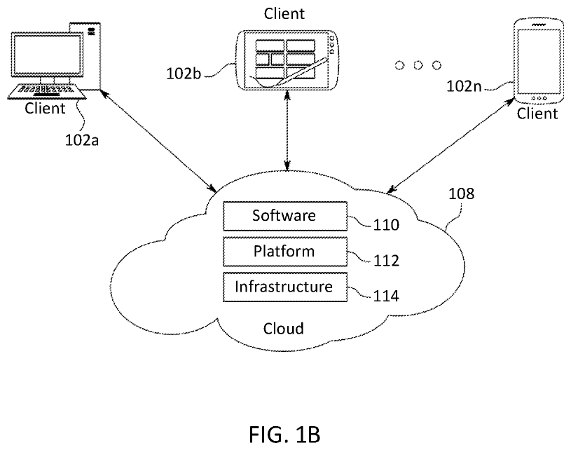

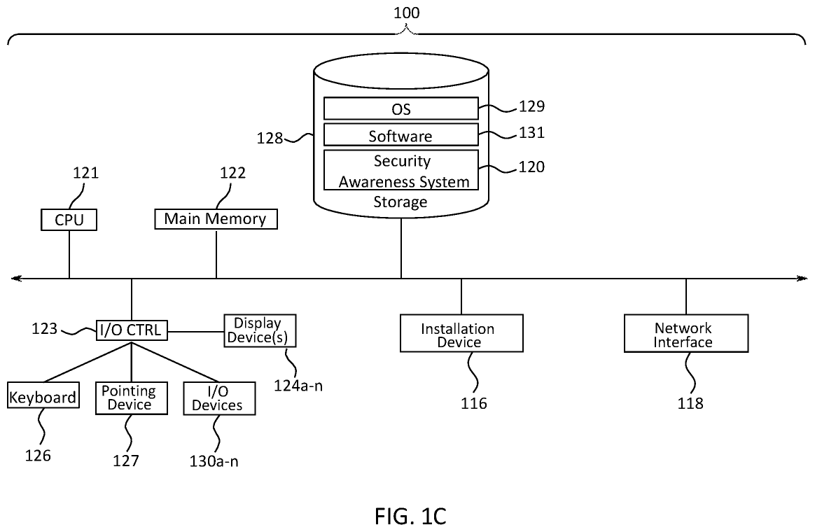

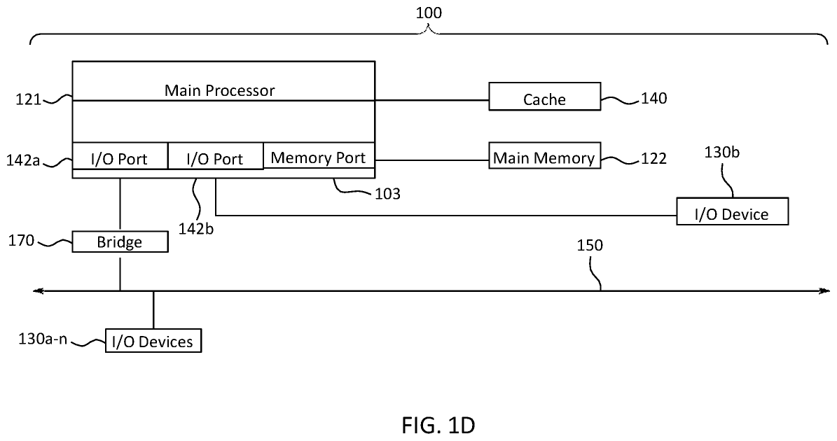

Prior to discussing specific embodiments of the present solution, it may be helpful to describe aspects of the operating environment as well as associated system components (e.g., hardware elements) in connection with the methods and systems described herein. Referring to FIG. 1A, an embodiment of a network environment is depicted. In a brief overview, the network environment includes one or more clients 102a-102n (also generally referred to as local machines(s) 102, client(s) 102, client node(s) 102, client machine(s) 102, client computer(s) 102, client device(s) 102, endpoint(s) 102, or endpoint node(s) 102) in communication with one or more servers 106a-106n (also generally referred to as server(s) 106, node(s) 106, machine(s) 106, or remote machine(s) 106) via one or more networks 104. In some embodiments, a client 102 has the capacity to function as both a client node seeking access to resources provided by a server and as a server providing access to hosted resources for other clients 102a-102n.

Although FIG. 1A shows a network 104 between the clients 102 and the servers 106, the clients 102 and the servers 106 may be on the same network 104. In some embodiments, there are multiple networks 104 between the clients 102 and the servers 106. In one of these embodiments, a network 104′ (not shown) may be a private network and a network 104 may be a public network. In another of these embodiments, a network 104 may be a private network and a network 104′ may be a public network. In still another of these embodiments, networks 104 and 104′ may both be private networks.

The network 104 may be connected via wired or wireless links. Wired links may include Digital Subscriber Line (DSL), coaxial cable lines, or optical fiber lines. Wireless links may include Bluetooth®, Bluetooth Low Energy (BLE), ANT/ANT+, ZigBee, Z-Wave, Thread, Wi-Fi®, Worldwide Interoperability for Microwave Access (WiMAX®), mobile WiMAX®, WiMAX®-Advanced, NFC, SigFox, LoRa, Random Phase Multiple Access (RPMA), Weightless-N/P/W, an infrared channel, or a satellite band. The wireless links may also include any cellular network standards to communicate among mobile devices, including standards that qualify as 1G, 2G, 3G, 4G, or 5G. The network standards may qualify as one or more generations of mobile telecommunication standards by fulfilling a specification or standards such as the specifications maintained by the International Telecommunication Union. The 3G standards, for example, may correspond to the International Mobile Telecommunications-2000 (IMT-2000) specification, and the 4G standards may correspond to the International Mobile Telecommunication Advanced (IMT-Advanced) specification. Examples of cellular network standards include AMPS, GSM, GPRS, UNITS, CDMA2000, CDMA-1×RTT, CDMA-EVDO, LTE, LTE-Advanced, LTE-M1, and Narrowband IoT (NB-IoT). Wireless standards may use various channel access methods, e.g., FDMA, TDMA, CDMA, or SDMA. In some embodiments, different types of data may be transmitted via different links and standards. In other embodiments, the same types of data may be transmitted via different links and standards.

The network 104 may be any type and/or form of network. The geographical scope of the network may vary widely and the network 104 can be a body area network (BAN), a personal area network (PAN), a local-area network (LAN), e.g., Intranet, a metropolitan area network (MAN), a wide area network (WAN), or the Internet. The topology of the network 104 may be of any form and may include, e.g., any of the following: point-to-point, bus, star, ring, mesh, or tree. The network 104 may be an overlay network which is virtual and sits on top of one or more layers of other networks 104′. The network 104 may be of any such network topology as known to those ordinarily skilled in the art capable of supporting the operations described herein. The network 104 may utilize different techniques and layers or stacks of protocols, including, e.g., the Ethernet protocol, the internet protocol suite (TCP/IP), the ATM (Asynchronous Transfer Mode) technique, the SONET (Synchronous Optical Networking) protocol, or the SDH (Synchronous Digital Hierarchy) protocol. The TCP/IP internet protocol suite may include application layer, transport layer, internet layer (including, e.g., IPv4 and IPv6), or the link layer. The network 104 may be a type of broadcast network, a telecommunications network, a data communication network, or a computer network.

In some embodiments, the system may include multiple, logically grouped servers 106. In one of these embodiments, the logical group of servers may be referred to as a server farm or a machine farm. In another of these embodiments, the servers 106 may be geographically dispersed. In other embodiments, a machine farm may be administered as a single entity. In still other embodiments, the machine farm includes a plurality of machine farms. The servers 106 within each machine farm can be heterogeneous—one or more of the servers 106 or machines 106 can operate according to one type of operating system platform (e.g., Windows, manufactured by Microsoft Corp. of Redmond, Washington), while one or more of the other servers 106 can operate according to another type of operating system platform (e.g., Unix, Linux, or Mac OSX).

In one embodiment, servers 106 in the machine farm may be stored in high-density rack systems, along with associated storage systems, and located in an enterprise data center. In this embodiment, consolidating the servers 106 in this way may improve system manageability, data security, the physical security of the system, and system performance by locating servers 106 and high-performance storage systems on localized high-performance networks. Centralizing the servers 106 and storage systems and coupling them with advanced system management tools allows more efficient use of server resources.

The servers 106 of each machine farm do not need to be physically proximate to another server 106 in the same machine farm. Thus, the group of servers 106 logically grouped as a machine farm may be interconnected using a wide-area network (WAN) connection or a metropolitan-area network (MAN) connection. For example, a machine farm may include servers 106 physically located in different continents or different regions of a continent, country, state, city, campus, or room. Data transmission speeds between servers 106 in the machine farm can be increased if the servers 106 are connected using a local-area network (LAN) connection or some form of direct connection. Additionally, a heterogeneous machine farm may include one or more servers 106 operating according to a type of operating system, while one or more other servers execute one or more types of hypervisors rather than operating systems. In these embodiments, hypervisors may be used to emulate virtual hardware, partition physical hardware, virtualize physical hardware, and execute virtual machines that provide access to computing environments, allowing multiple operating systems to run concurrently on a host computer. Native hypervisors may run directly on the host computer. Hypervisors may include VMware ESX/ESXi, manufactured by VMWare, Inc., of Palo Alta, California; the Xen hypervisor, an open source product whose development is overseen by Citrix Systems, Inc. of Fort Lauderdale, Florida; the HYPER-V hypervisors provided by Microsoft, or others. Hosted hypervisors may run within an operating system on a second software level. Examples of hosted hypervisors may include VMWare Workstation and VirtualBox, manufactured by Oracle Corporation of Redwood City, California.

Management of the machine farm may be de-centralized. For example, one or more servers 106 may comprise components, subsystems, and modules to support one or more management services for the machine farm. In one of these embodiments, one or more servers 106 provide functionality for management of dynamic data, including techniques for handling failover, data replication, and increasing the robustness of the machine farm. Each server 106 may communicate with a persistent store and, in some embodiments, with a dynamic store.

Server 106 may be a file server, application server, web server, proxy server, appliance, network appliance, gateway, gateway server, virtualization server, deployment server, SSL VPN server, or firewall. In one embodiment, a plurality of servers 106 may be in the path between any two communicating servers 106.

Referring to FIG. 1B, a cloud computing environment is depicted. A cloud computing environment may provide client 102 with one or more resources provided by a network environment. The cloud computing environment may include one or more clients 102a-102n, in communication with the cloud 108 over one or more networks 104. Clients 102 may include, e.g., thick clients, thin clients, and zero clients. A thick client may provide at least some functionality even when disconnected from the cloud 108 or servers 106. A thin client or zero client may depend on the connection to the cloud 108 or server 106 to provide functionality. A zero client may depend on the cloud 108 or other networks 104 or servers 106 to retrieve operating system data for the client device 102. The cloud 108 may include back end platforms, e.g., servers 106, storage, server farms or data centers.

The cloud 108 may be public, private, or hybrid. Public clouds may include public servers 106 that are maintained by third parties to the clients 102 or the owners of the clients. The servers 106 may be located off-site in remote geographical locations as disclosed above or otherwise. Public clouds may be connected to the servers 106 over a public network. Private clouds may include private servers 106 that are physically maintained by clients 102 or owners of clients. Private clouds may be connected to the servers 106 over a private network 104. Hybrid clouds 109 may include both the private and public networks 104 and servers 106.

The cloud 108 may also include a cloud-based delivery, e.g., Software as a Service (SaaS) 110, Platform as a Service (PaaS) 112, and Infrastructure as a Service (IaaS) 114. IaaS may refer to a user renting the user of infrastructure resources that are needed during a specified time period. IaaS provides may offer storage, networking, servers, or virtualization resources from large pools, allowing the users to quickly scale up by accessing more resources as needed. Examples of IaaS include Amazon Web Services (AWS) provided by Amazon, Inc. of Seattle, Washington, Rackspace Cloud provided by Rackspace Inc. of San Antonio, Texas, Google Compute Engine provided by Google Inc. of Mountain View, California, or RightScale provided by RightScale, Inc. of Santa Barbara, California. PaaS providers may offer functionality provided by IaaS, including, e.g., storage, networking, servers, or virtualization, as well as additional resources, e.g., the operating system, middleware, or runtime resources. Examples of PaaS include Windows Azure provided by Microsoft Corporation of Redmond, Washington, Google App Engine provided by Google Inc., and Heroku provided by Heroku, Inc. of San Francisco California. SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include Google Apps provided by Google Inc., Salesforce provided by Salesforce.com Inc. of San Francisco, California, or Office365 provided by Microsoft Corporation. Examples of SaaS may also include storage providers, e.g., Dropbox provided by Dropbox Inc. of San Francisco, California, Microsoft OneDrive provided by Microsoft Corporation, Google Drive provided by Google Inc., or Apple iCloud provided by Apple Inc. of Cupertino, California.

Clients 102 may access IaaS resources with one or more IaaS standards, including, e.g., Amazon Elastic Compute Cloud (EC2), Open Cloud Computing Interface (OCCI), Cloud Infrastructure Management Interface (CIMI), or OpenStack standards. Some IaaS standards may allow clients access to resources over HTTP and may use Representational State Transfer (REST) protocol or Simple Object Access Protocol (SOAP). Clients 102 may access PaaS resources with different PaaS interfaces. Some PaaS interfaces use HTTP packages, standard Java APIs, JavaMail API, Java Data Objects (JDO), Java Persistence API (JPA), Python APIs, web integration APIs for different programming languages including, e.g., Rack for Ruby, WSGI for Python, or PSGI for Perl, or other APIs that may be built on REST, HTTP, XML, or other protocols. Clients 102 may access SaaS resources through the use of web-based user interfaces, provided by a web browser (e.g., Google Chrome, Microsoft Internet Explorer, or Mozilla Firefox provided by Mozilla Foundation of Mountain View, California). Clients 102 may also access SaaS resources through smartphone or tablet applications, including e.g., Salesforce Sales Cloud, or Google Drive App. Clients 102 may also access SaaS resources through the client operating system, including e.g., Windows file system for Dropbox.

In some embodiments, access to IaaS, PaaS, or SaaS resources may be authenticated. For example, a server or authentication server may authenticate a user via security certificates, HTTPS, or API keys. API keys may include various encryption standards such as, e.g., Advanced Encryption Standard (AES). Data resources may be sent over Transport Layer Security (TLS) or Secure Sockets Layer (SSL).

The client 102 and server 106 may be deployed as and/or executed on any type and form of computing device, e.g., a computer, network device or appliance capable of communicating on any type and form of network and performing the operations described herein.

FIG. 1C and FIG. 1D depict block diagrams of a computing device 100 useful for practicing an embodiment of the client 102 or a server 106. As shown in FIG. 1C and FIG. 1D, each computing device 100 includes a central processing unit 121, and a main memory unit 122. As shown in FIG. 1C, a computing device 100 may include a storage device 128, an installation device 116, a network interface 118, and I/O controller 123, display devices 124a-124n, a keyboard 126 and a pointing device 127, e.g., a mouse. The storage device 128 may include, without limitation, an operating system 129, software 131, and software of a security awareness system 120. As shown in FIG. 1D, each computing device 100 may also include additional optional elements, e.g., a memory port 103, a bridge 170, one or more input/output devices 130a-130n (generally referred to using reference numeral 130), and a cache memory 140 in communication with the central processing unit 121.

The central processing unit 121 is any logic circuitry that responds to, and processes instructions fetched from the main memory unit 122. In many embodiments, the central processing unit 121 is provided by a microprocessor unit, e.g.: those manufactured by Intel Corporation of Mountain View, California; those manufactured by Motorola Corporation of Schaumburg, Illinois; the ARM processor and TEGRA system on a chip (SoC) manufactured by Nvidia of Santa Clara, California; the POWER7 processor, those manufactured by International Business Machines of White Plains, New York; or those manufactured by Advanced Micro Devices of Sunnyvale, California. The computing device 100 may be based on any of these processors, or any other processor capable of operating as described herein. The central processing unit 121 may utilize instruction level parallelism, thread level parallelism, different levels of cache, and multi-core processors. A multi-core processor may include two or more processing units on a single computing component. Examples of multi-core processors include the AMD PHENOM IIX2, INTEL CORE i5 and INTEL CORE i7.

Main memory unit 122 may include one or more memory chips capable of storing data and allowing any storage location to be directly accessed by the microprocessor 121. Main memory unit 122 may be volatile and faster than storage 128 memory. Main memory units 122 may be Dynamic Random-Access Memory (DRAM) or any variants, including Static Random-Access Memory (SRAM), Burst SRAM or SynchBurst SRAM (BSRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Single Data Rate Synchronous DRAM (SDR SDRAM), Double Data Rate SDRAM (DDR SDRAM), Direct Rambus DRAM (DRDRAM), or Extreme Data Rate DRAM (XDR DRAM). In some embodiments, the main memory 122 or the storage 128 may be non-volatile; e.g., non-volatile Random Access Memory (NVRAM), flash memory non-volatile static RAM (nvSRAM), Ferroelectric RAM (FeRAM), Magnetoresistive RAM (MRAM), Phase-change RAM (PRAM), conductive-bridging RAM (CBRAM), Silicon-Oxide-Nitride-Oxide-Silicon (SONOS), Resistive RAM (RRAM), Racetrack, Nano-RAM (NRAM), or Millipede memory. The main memory 122 may be based on any of the above described memory chips, or any other available memory chips capable of operating as described herein. In the embodiment shown in FIG. 1C, the processor 121 communicates with main memory 122 via a system bus 150 (described in more detail below). FIG. 1D depicts an embodiment of a computing device 100 in which the processor communicates directly with main memory 122 via a memory port 103. For example, in FIG. 1D the main memory 122 may be DRDRAM.

FIG. 1D depicts an embodiment in which the main processor 121 communicates directly with cache memory 140 via a secondary bus, sometimes referred to as a backside bus. In other embodiments, the main processor 121 communicates with cache memory 140 using the system bus 150. Cache memory 140 typically has a faster response time than main memory 122 and is typically provided by SRAM, BSRAM, or EDRAM. In the embodiment shown in FIG. 1D, the processor 121 communicates with various I/O devices 130 via a local system bus 150. Various buses may be used to connect the central processing unit 121 to any of the I/O devices 130, including a PCI bus, a PCI-X bus, a PCI-Express bus, or a NuBus. For embodiments in which the I/O device is a video display 124, the processor 121 may use an Advanced Graphic Port (AGP) to communicate with the display 124 or the I/O controller 123 for the display 124. FIG. 1D depicts an embodiment of a computer 100 in which the main processor 121 communicates directly with I/O device 130b or other processors 121′ via HYPERTRANSPORT, RAPIDIO, or INFINIBAND communications technology. FIG. 1D also depicts an embodiment in which local busses and direct communication are mixed: the processor 121 communicates with I/O device 130a using a local interconnect bus while communicating with I/O device 130b directly.

A wide variety of I/O devices 130a-130n may be present in the computing device 100. Input devices may include keyboards, mice, trackpads, trackballs, touchpads, touch mice, multi-touch touchpads and touch mice, microphones, multi-array microphones, drawing tablets, cameras, single-lens reflex cameras (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. Output devices may include video displays, graphical displays, speakers, headphones, inkjet printers, laser printers, and 3D printers.

Devices 130a-130n may include a combination of multiple input or output devices, including, e.g., Microsoft KINECT, Nintendo Wiimote for the WII, Nintendo WII U GAMEPAD, or Apple iPhone. Some devices 130a-130n allow gesture recognition inputs through combining some of the inputs and outputs. Some devices 130a-130n provide for facial recognition which may be utilized as an input for different purposes including authentication and other commands. Some devices 130a-130n provide for voice recognition and inputs, including, e.g., Microsoft KINECT, SIRI for iPhone by Apple, Google Now or Google Voice Search, and Alexa by Amazon.

Additional devices 130a-130n have both input and output capabilities, including, e.g., haptic feedback devices, touchscreen displays, or multi-touch displays. Touchscreen displays, multi-touch displays, touchpads, touch mice, or other touch sensing devices may use different technologies to sense touch, including, e.g., capacitive, surface capacitive, projected capacitive touch (PCT), in cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, e.g., pinch, spread, rotate, scroll, or other gestures. Some touchscreen devices, including, e.g., Microsoft PIXELSENSE or Multi-Touch Collaboration Wall, may have larger surfaces, such as on a table-top or on a wall, and may also interact with other electronic devices. Some I/O devices 130a-130n, display devices 124a-124n or group of devices may be augmented reality devices. An I/O controller may control the I/O devices 123 as shown in FIG. 1C. The I/O controller may control one or more I/O devices, such as, e.g., a keyboard 126 and a pointing device 127, e.g., a mouse or optical pen. Furthermore, an I/O device may also provide storage and/or an installation medium 116 for the computing device 100. In still other embodiments, the computing device 100 may provide USB connections (not shown) to receive handheld USB storage devices. In further embodiments, a I/O device 130 may be a bridge between the system bus 150 and an external communication bus, e.g., a USB bus, a SCSI bus, a FireWire bus, an Ethernet bus, a Gigabit Ethernet bus, a Fiber Channel bus, or a Thunderbolt bus.

In some embodiments, display devices 124a-124n may be connected to I/O controller 123. Display devices may include, e.g., liquid crystal displays (LCD), thin film transistor LCD (TFT-LCD), blue phase LCD, electronic papers (e-ink) displays, flexile displays, light emitting diode (LED) displays, digital light processing (DLP) displays, liquid crystal on silicon (LCOS) displays, organic light-emitting diode (OLED) displays, active-matrix organic light-emitting diode (AMOLED) displays, liquid crystal laser displays, time-multiplexed optical shutter (TMOS) displays, or 3D displays. Examples of 3D displays may use, e.g., stereoscopy, polarization filters, active shutters, or auto stereoscopy. Display devices 124a-124n may also be a head-mounted display (HMD). In some embodiments, display devices 124a-124n or the corresponding I/O controllers 123 may be controlled through or have hardware support for OPENGL or DIRECTX API or other graphics libraries.

In some embodiments, the computing device 100 may include or connect to multiple display devices 124a-124n, which each may be of the same or different type and/or form. As such, any of the I/O devices 130a-130n and/or the I/O controller 123 may include any type and/or form of suitable hardware, software, or combination of hardware and software to support, enable or provide for the connection and use of multiple display devices 124a-124n by the computing device 100. For example, the computing device 100 may include any type and/or form of video adapter, video card, driver, and/or library to interface, communicate, connect, or otherwise use the display devices 124a-124n. In one embodiment, a video adapter may include multiple connectors to interface to multiple display devices 124a-124n. In other embodiments, the computing device 100 may include multiple video adapters, with each video adapter connected to one or more of the display devices 124a-124n. In some embodiments, any portion of the operating system of the computing device 100 may be configured for using multiple displays 124a-124n. In other embodiments, one or more of the display devices 124a-124n may be provided by one or more other computing devices 100a or 100b connected to the computing device 100, via the network 104. In some embodiments, software may be designed and constructed to use another computer's display device as a second display device 124a for the computing device 100. For example, in one embodiment, an Apple iPad may connect to a computing device 100 and use the display of the device 100 as an additional display screen that may be used as an extended desktop. One of ordinarily skill in the art will recognize and appreciate the various ways and embodiments that a computing device 100 may be configured to have multiple display devices 124a-124n.

Referring again to FIG. 1C, the computing device 100 may comprise a storage device 128 (e.g., one or more hard disk drives or redundant arrays of independent disks) for storing an operating system or other related software, and for storing application software programs such as any program related to the software of a security awareness system 120. Examples of storage device 128 include, e.g., hard disk drive (HDD); optical drive including CD drive, DVD drive, or BLU-RAY drive; solid-state drive (SSD); USB flash drive; or any other device suitable for storing data. Some storage devices may include multiple volatile and non-volatile memories, including, e.g., solid state hybrid drives that combine hard disks with solid state cache. Some storage devices 128 may be non-volatile, mutable, or read-only. Some storage devices 128 may be internal and connect to the computing device 100 via a bus 150. Some storage devices 128 may be external and connect to the computing device 100 via a I/O device 130 that provides an external bus. Some storage devices 128 may connect to the computing device 100 via the network interface 118 over a network 104, including, e.g., the Remote Disk for MACBOOK AIR by Apple. Some client devices 100 may not require a non-volatile storage device 128 and may be thin clients or zero clients 102. Some storage devices 128 may also be used as an installation device 116 and may be suitable for installing software and programs. Additionally, the operating system and the software can be run from a bootable medium, for example, a bootable CD, e.g., KNOPPIX, a bootable CD for GNU/Linux that is available as a GNU/Linux distribution from knoppix.net.

Client device 100 may also install software or application from an application distribution platform. Examples of application distribution platforms include the App Store for iOS provided by Apple, Inc., the Mac App Store provided by Apple, Inc., GOOGLE PLAY for Android OS provided by Google Inc., Chrome Webstore for CHROME OS provided by Google Inc., and Amazon Appstore for Android OS and KINDLE FIRE provided by Amazon.com, Inc. An application distribution platform may facilitate installation of software on a client device 102. An application distribution platform may include a repository of applications on a server 106 or a cloud 108, which the clients 102a-102n may access over a network 104. An application distribution platform may include application developed and provided by various developers. A user of a client device 102 may select, purchase and/or download an application via the application distribution platform.

Furthermore, the computing device 100 may include a network interface 118 to interface to the network 104 through a variety of connections including, but not limited to, standard telephone lines LAN or WAN links (e.g., 802.11, T1, T3, Gigabit Ethernet, InfiniBand), broadband connections (e.g., ISDN, Frame Relay, ATM, Gigabit Ethernet, Ethernet over SONET, ADSL, VDSL, BPON, GPON, fiber optical including FiOS), wireless connections, or some combination of any or all of the above. Connections can be established using a variety of communication protocols (e.g., TCP/IP, Ethernet, ARCNET, SONET, SDH, Fiber Distributed Data Interface (FDDI), IEEE 802.1 1a/b/g/n/ac CDMA, GSM, WiMAX, and direct asynchronous connections). In one embodiment, the computing device 100 communicates with other computing devices 100′ via any type and/or form of gateway or tunneling protocol e.g., Secure Socket Layer (SSL) or Transport Layer Security (TLS), or the Citrix Gateway Protocol manufactured by Citrix Systems, Inc. The network interface 118 may comprise a built-in network adapter, network interface card, PCMCIA network card, EXPRESSCARD network card, card bus network adapter, wireless network adapter, USB network adapter, modem, or any other device suitable for interfacing the computing device 100 to any type of network capable of communication and performing the operations described herein.

A computing device 100 of the sort depicted in FIG. 1B and FIG. 1C may operate under the control of an operating system, which controls scheduling of tasks and access to system resources. The computing device 100 can be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 2000, WINDOWS Server 2012, WINDOWS CE, WINDOWS Phone, WINDOWS XP, WINDOWS VISTA, and WINDOWS 7, WINDOWS RT, WINDOWS 8 and WINDOW 10, all of which are manufactured by Microsoft Corporation of Redmond, Washington; MAC OS and iOS, manufactured by Apple, Inc.; and Linux, a freely-available operating system, e.g., Linux Mint distribution (“distro”) or Ubuntu, distributed by Canonical Ltd. of London, United Kingdom; or Unix or other Unix-like derivative operating systems; and Android, designed by Google Inc., among others. Some operating systems, including, e.g., the CHROME OS by Google Inc., may be used on zero clients or thin clients, including, e.g., CHROMEBOOKS.

The computer system 100 can be any workstation, telephone, desktop computer, laptop or notebook computer, netbook, ULTRABOOK, tablet, server, handheld computer, mobile telephone, smartphone or other portable telecommunications device, media playing device, a gaming system, mobile computing device, or any other type and/or form of computing, telecommunications or media device that is capable of communication. The computer system 100 has sufficient processor power and memory capacity to perform the operations described herein. In some embodiments, the computing device 100 may have different processors, operating systems, and input devices consistent with the device. The Samsung GALAXY smartphones, e.g., operate under the control of Android operating system developed by Google, Inc. GALAXY smartphones receive input via a touch interface.

In some embodiments, the computing device 100 is a gaming system. For example, the computer system 100 may comprise a PLAYSTATION 3, or PERSONAL PLAYSTATION PORTABLE (PSP), or a PLAYSTATION VITA device manufactured by the Sony Corporation of Tokyo, Japan, or a NINTENDO DS, NINTENDO 3DS, NINTENDO WII, or a NINTENDO WII U device manufactured by Nintendo Co., Ltd., of Kyoto, Japan, or an XBOX 360 device manufactured by Microsoft Corporation.

In some embodiments, the computing device 100 is a digital audio player such as the Apple IPOD, IPOD Touch, and IPOD NANO lines of devices, manufactured by Apple Computer of Cupertino, California. Some digital audio players may have other functionality, including, e.g., a gaming system or any functionality made available by an application from a digital application distribution platform. For example, the iPod Touch may access the Apple App Store. In some embodiments, the computing device 100 is a portable media player or digital audio player supporting file formats including, but not limited to, MP3, WAV, M4A/AAC, WMA Protected AAC, AIFF, Audible audiobook, Apple lossless audio file formats and .mov, .m4v, and .mp4 MPEG-4 (H.264/MPEG-4 AVC) video file formats.

In some embodiments, the computing device 100 is a tablet e.g., the IPAD line of devices by Apple; GALAXY TAB family of devices by Samsung; or KINDLE FIRE, by Amazon.com, Inc. of Seattle, Washington. In other embodiments, the computing device 100 is an eBook reader, e.g., the KINDLE family of devices by Amazon.com, or NOOK family of devices by Barnes & Noble, Inc. of New York City, New York.

In some embodiments, the communications device 102 includes a combination of devices, e.g., a smartphone combined with a digital audio player or portable media player. For example, one of these embodiments is a smartphone, e.g., the iPhone family of smartphones manufactured by Apple, Inc.; a Samsung GALAXY family of smartphones manufactured by Samsung, Inc; or a Motorola DROID family of smartphones. In yet another embodiment, the communications device 102 is a laptop or desktop computer equipped with a web browser and a microphone and speaker system, e.g., a telephony headset. In these embodiments, the communications devices 102 are web-enabled and can receive and initiate phone calls. In some embodiments, a laptop or desktop computer is also equipped with a webcam or other video capture device that enables video chat and video call.

In some embodiments, the status of one or more machines 102, 106 in network 104 is monitored, as part of network management. In one of these embodiments, the status of a machine may include an identification of load information (e.g., the number of processes on the machine, CPU, and memory utilization), of port information (e.g., the number of available communication ports and the port addresses), or of session status (e.g., the duration and type of processes, and whether a process is active or idle). In another of these embodiments, this information may be identified by a plurality of metrics, and the plurality of metrics can be applied at least in part towards decisions in load distribution, network traffic management, and network failure recovery as well as any aspects of operations of the present solution described herein. Aspects of the operating environments and components described above will become apparent in the context of the systems and methods disclosed herein.

### B. Systems And Methods for User Feedback on Receiving Simulated Phishing Communications

This disclosure relates to security awareness management. In particular, the present disclosure relates to systems and methods for collecting feedback from users about reasons for interacting with simulated phishing communications. The present disclosure further relates to processing the feedback to target more effective security awareness training and template selection for future simulated phishing communications.

Cybersecurity incidents cost companies millions of dollars each year in actual costs and can cause customers to lose trust in an organization. The incidents of cybersecurity attacks and the costs of mitigating the damage are increasing every year. Many organizations use cybersecurity tools such as antivirus, anti-ransomware, anti-phishing, and other quarantine platforms to detect and intercept known cybersecurity attacks. However, new, and unknown security threats involving social engineering may not be readily detectable by such cyber security tools, and the organizations may have to rely on their employees (also referred to as users) to recognize such threats. To enable their users to stop or reduce the rate of cybersecurity incidents, organizations may conduct security awareness training for their users. Organizations may conduct security awareness training through in-house cybersecurity teams or may use third parties which are experts in matters of cybersecurity.

To increase cybersecurity awareness of users, one security awareness training methodology used by organizations is execution of simulated phishing campaigns. A simulated phishing campaign is an organized combination of two or more simulated phishing communications (or simulated phishing messages) directed to one or more users of an organization. A simulated phishing campaign may include simulated phishing communications that are derived from one or more simulated phishing templates, and the simulated phishing campaign may have an identified purpose such as providing security awareness training on a specific topic. In examples, one or more simulated phishing communication of the simulated phishing campaign interrelates with one or more other simulated phishing communications of the simulated phishing campaign to increase the likelihood that a user will interact with one or more of the simulated phishing communications. A simulated phishing communication may test a user to see if the user is likely to recognize a malicious phishing communication and act appropriately upon receiving one. In examples, the simulated phishing communications may be generated by employing one or more of the same types of exploits as a malicious phishing communication, and in examples have one or more elements such as links, attachments, or macros similar to what a malicious phishing communication may have, except that if a user interacts with a simulated phishing communication or the one or more elements, there is no harm caused to the organization due to the interaction.

In examples, simulated phishing templates may be used for creating and delivering simulated phishing communications to the users. A simulated phishing template is a framework used to create simulated phishing communications (or simulated phishing messages). In some examples, the simulated phishing template may specify the layout and content of the simulated phishing communications. In some examples, the simulated phishing template may be designed according to theme or subject matter. The simulated phishing template may be configurable by a system administrator, a security authority, or an artificial intelligence (AI) algorithm. In an example, the system administrator may be able to add dynamic content to the simulated phishing template, such as a field that will populate with the recipient's name and email address when the simulated phishing communication is prepared based on the simulated phishing template for sending to a recipient. In an example, the system administrator may be able to select one or more exploits to include in the simulated phishing template, for example, one or more simulated malicious URLs, one or more simulated macros, and/or one or more simulated attachments. An exploit is a user interactable phishing tool in templates that can be clicked on or otherwise interacted with by a user. In some examples, a system administrator may select a simulated phishing template from a pool of available simulated phishing templates and may send such a “stock” template to users unchanged.

As part of a configuration of a simulated phishing campaign, a system administrator may select a simulated phishing template on which simulated phishing communications will be based and sent to users. In examples, parameters of the simulated phishing template may be adjusted to target the simulated phishing communication to a user more precisely or to target specific aspects of security awareness which are being tested. In examples, on receiving the simulated phishing communication based on the simulated phishing template, the user may interact with the simulated phishing communication and may “fail” the test posed by the simulated phishing template (for example, the user may click on a link in the simulated phishing communication, or the user may forward the simulated phishing communication to another user). In some examples, the user may report the simulated phishing communication as a threat (for example, by using an email client plug-in or by forwarding the simulated phishing communication to a reporting email address). While the user may pass or fail the test, and the user's risk score or training requirements may be updated accordingly, it is not known what the user was thinking in the moment that he or she interacted with the simulated phishing communication. Accordingly, reasons for the user interaction with the simulated phishing communication may not be known.

The present disclosure describes systems and methods for collecting feedback from one or more users about the reasons why they interacted with one or more simulated phishing communications. The feedback may be categorized and analyzed and used to target more effective security awareness training and template selection for future simulated phishing campaigns.

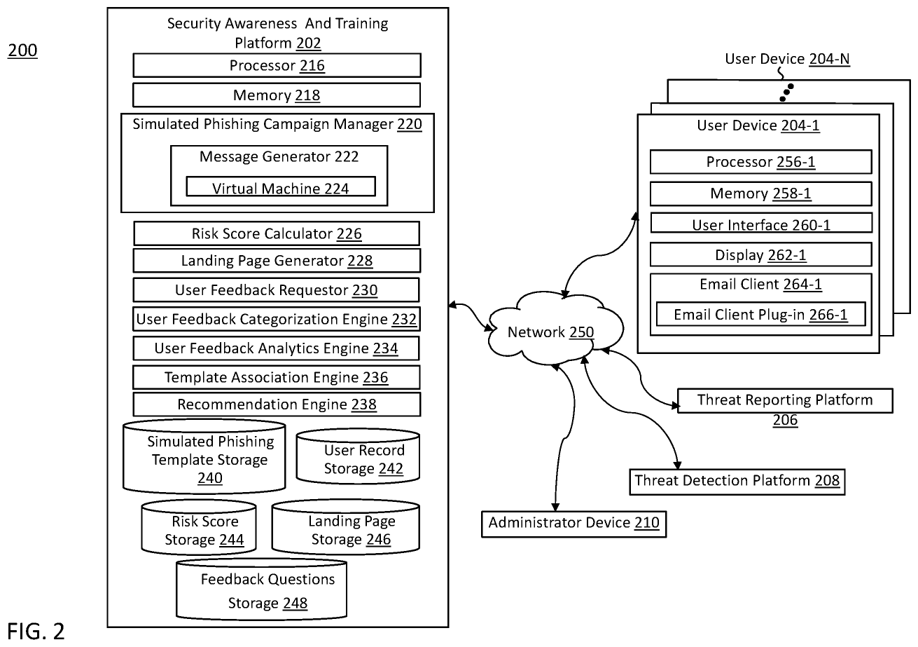

Referring to FIG. 2, in a general overview, FIG. 2 depicts some of the server architecture of an implementation of system 200 for collecting and processing user feedback about reasons for interacting with simulated phishing communications, according to one or more embodiments. System 200 may be a part of security awareness system 120. System 200 may include security awareness and training platform 202, user device(s) 204-(1-N), threat reporting platform 206, threat detection platform 208, administrator device 210, and network 250 enabling communication between the system components for information exchange. Network 250 may be an example or instance of network 104, details of which are provided with reference to FIG. 1A and its accompanying description.

According to some embodiments, each of security awareness and training platform 202, threat reporting platform 206, and threat detection platform 208 may be implemented in a variety of computing systems, such as a mainframe computer, a server, a network server, a laptop computer, a desktop computer, a notebook, a workstation, and the like. In an implementation, each of security awareness and training platform 202, threat reporting platform 206, and threat detection platform 208 may be implemented in a server, such as server 106 shown in FIG. 1A. In some implementations, security awareness and training platform 202, threat reporting platform 206, and threat detection platform 208 may be implemented by a device, such as computing device 100 shown in FIG. 1C and FIG. 1D. In some embodiments, security awareness and training platform 202, threat reporting platform 206, and threat detection platform 208 may be implemented as a part of a cluster of servers. In some embodiments, each of security awareness and training platform 202, threat reporting platform 206, and threat detection platform 208 may be implemented across a plurality of servers, thereby, tasks performed by each of security awareness and training platform 202, threat reporting platform 206, and threat detection platform 208 may be performed by the plurality of servers. These tasks may be allocated among the cluster of servers by an application, a service, a daemon, a routine, or other executable logic for task allocation.

In one or more embodiments, security awareness and training platform 202 may be a system that manages items relating to cybersecurity awareness for an organization. The organization may be an entity that is subscribed to or that makes use of services provided by security awareness and training platform 202. In examples, the organization may be expanded to include all users within the organization, vendors to the organization, or partners of the organization. According to an implementation, security awareness and training platform 202 may be deployed by the organization to monitor and educate users thereby reducing cybersecurity threats to the organization. In an implementation, security awareness and training platform 202 may educate users within the organization by performing simulated phishing campaigns on the users. In an example, a user of the organization may include an individual that is tested and trained by security awareness and training platform 202. In examples, a user of the organization may include an individual that can or does receive electronic messages. For example, the user may be an employee of the organization, a partner of the organization, a member of a group, an individual who acts in any capacity with security awareness and training platform 202 (such as a system administrator or a security administrator), or anyone associated with the organization. The system administrator may be an individual or team responsible for managing organizational cybersecurity aspects on behalf of an organization. The system administrator may oversee and manage security awareness and training platform 202 to ensure cybersecurity awareness training goals of the organization are met. For example, the system administrator may oversee Information Technology (IT) systems of the organization for configuration of system personal information use, managing simulated phishing campaigns, identification, and classification of threats within reported emails, creation of user feedback questions, and any other element within security awareness and training platform 202. Examples of system administrator include an IT department, a security administrator, a security team, a manager, or an Incident Response (IR) team. In some implementations, security awareness and training platform 202 may be owned or managed or otherwise associated with an organization or any entity authorized thereof.

A simulated phishing attack is a technique of testing a user to see whether the user is likely to recognize a true malicious phishing attack and act appropriately upon receiving the malicious phishing attack. The simulated phishing attack may include links, attachments, macros, or any other simulated phishing threat (also referred to as an exploit) that resembles a real phishing threat. In response to user interaction with the simulated phishing attack, for example, if the user clicks on a link (i.e., a simulated phishing link), the user may be provided with security awareness training. In an example, security awareness and training platform 202 may be a Computer Based Security Awareness Training (CBSAT) system that performs security services such as performing simulated phishing attacks on a user or a set of users of the organization as a part of security awareness training.

According to some embodiments, security awareness and training platform 202 may include processor 216 and memory 218. For example, processor 216 and memory 218 of security awareness and training platform 202 may be CPU 121 and main memory 122, respectively, as shown in FIG. 1C and FIG. 1D. Further, security awareness and training platform 202 may include simulated phishing campaign manager 220. Simulated phishing campaign manager 220 may include various functionalities that may be associated with cybersecurity awareness training. In an implementation, simulated phishing campaign manager 220 may be an application or a program that manages various aspects of a simulated phishing attack, for example, tailoring and/or executing a simulated phishing attack. A simulated phishing attack may test the readiness of a user to manage phishing attacks such that malicious actions are prevented. For instance, simulated phishing campaign manager 220 may monitor and control timing of various aspects of a simulated phishing attack including processing requests for access to attack results, and performing other tasks related to the management of a simulated phishing attack.

In some embodiments, simulated phishing campaign manager 220 may include message generator 222 having virtual machine 224. Message generator 222 may be an application, service, daemon, routine, or other executable logic for generating messages. The messages generated by message generator 222 may be of any appropriate format. For example, the messages may be email messages, text messages, short message service (SMS) messages, instant messaging (IM) messages used by messaging applications such as, e.g., WhatsApp™, or any other type of message. In examples, a message type to be used in a particular simulated phishing communication may be determined by, for example, simulated phishing campaign manager 220. Message generator 222 generates messages in any appropriate manner, e.g., by running an instance of an application that generates the desired message type, such as running, e.g., a Gmail® application, Microsoft Outlook™, WhatsApp™, a text messaging application, or any other appropriate application. Message generator 222 may generate messages by running a messaging application on virtual machine 224 or in any other appropriate environment. Message generator 222 generates the messages to be in a format consistent with specific messaging platforms, for example, Outlook 365™, Outlook Web Access (OWA), Webmail™, iOS®, Gmail®, and such formats.

In an implementation, message generator 222 may be configured to generate simulated phishing communications using a simulated phishing template. A simulated phishing template is a framework used to create simulated phishing communications. In some examples, a simulated phishing template may specify the layout and content of one or more simulated phishing communications. In an example, a simulated phishing template may include fixed content including text and images. In some examples, a simulated phishing template may be designed according to theme or subject matter. The simulated phishing template may be configurable by a system administrator. For example, the system administrator may be able to add dynamic content to the simulated phishing template, such as a field that will populate with a recipient's name and email address when message generator 222 prepares simulated phishing communications based on the simulated phishing template for sending to a user. In an example, the system administrator may be able to select one or more exploits to include in the simulated phishing template, for example, one or more simulated malicious URLs, one or more simulated macros, and/or one or more simulated attachments. An exploit is an interactable phishing tool in in simulated phishing communications that can be clicked on or otherwise interacted with by a user. A simulated phishing template customized by the system administrator can be used for multiple different users in the organization over a period of time or for different campaigns. In some examples, a system administrator may select a simulated phishing template from a pool of available simulated phishing templates and may send such a “stock” template to users unchanged. The simulated phishing template may be designed to resemble a known real phishing attack so simulated phishing communications based on the simulated phishing template may be used to train users to recognize these real attacks.

Referring again to FIG. 2, in some embodiments, security awareness and training platform 202 may include risk score calculator 226. Risk score calculator 226 may be an application or a program for determining and maintaining risk scores for users in an organization. A risk score of a user may be a representation of vulnerability of the user to a malicious attack or the likelihood that a user may engage in an action associated with a security risk. In an implementation, risk score calculator 226 may maintain more than one risk score for each user. Each such risk score may represent one or more aspects of vulnerability of the user to a specific cyberattack. In an implementation, risk score calculator 226 may calculate risk scores for a group of users, for the organization, for an industry (for example, an industry to which the organization belongs), a geography, etc. In an example, a risk score of the user may be modified based on the user's responses to simulated phishing communications, completion of training by the user, a current position of the user in the organization, a size of a network of the user, an amount of time the user has held the current position in the organization, a new position of the user in the organization if the position changes, for example due to a promotion or change in department and/or any other attribute that can be associated with the user.

According to some embodiments, security awareness and training platform 202 may include landing page generator 228. In an implementation, landing page generator 228 may be an application or a program for creation or modification of landing pages to facilitate security awareness training of users in the organization. In an example, a landing page may be a webpage or an element of a webpage that appears in response to a user interaction with a simulated phishing message, such as clicking on a link, downloading an attachment or such actions, which in some examples enables provisioning of training materials.

According to some embodiments, security awareness and training platform 202 may include user feedback requestor 230. In an implementation, user feedback requestor 230 may be an application or a program for requesting information (feedback) from users about why they interacted with one or more simulated phishing communications. User feedback requestor 230 may be configured to interact with simulated phishing campaign manager 220, for example receiving information from simulated phishing campaign manager that one or more users failed one or more simulated phishing communications of a simulated phishing campaign, such that user feedback requestor may prompt the user or users that failed for feedback. In some examples, user feedback requestor 230 may be configured to interact with landing page storage 246, for example to enable the collection of user feedback when a landing page is presented to a user that failed a simulated phishing attack. In some examples, user feedback requestor is configure to interact with risk score storage 244, for example to retrieve a risk score related to the user that failed the test, where in some examples the failing user's risk score may be an input into the determination of what user feedback to request or into the determination of how to request feedback from the failing user.

In some examples, user feedback requestor 230 may be configured to interact with user record storage 242, for example in retrieve information or attributes related to the failing user, which in some examples may be an input into the determination of what user feedback to request or into the determination of how to request feedback from the failing user. In examples, user feedback requestor 230 may be configured to interact with feedback questions storage 248, for example to retrieve questions to solicit feedback from a user that has failed a simulated phishing attack, according to some examples.

According to some embodiments, security awareness and training platform 202 may include user feedback categorization engine 232. In an implementation, user feedback categorization engine 232 may be an application or a program for collating feedback gathered from the users (i.e., user feedback) into specific categories. User feedback categorization engine may be configured to interact with user feedback requestor, such that user feedback returned in response to a request for user feedback may be collected by user feedback requestor and stored in a memory or storage, such as memory 218, and user feedback categorization engine 232 may access the user feedback collected from a plurality of users, and may assign different types of feedback into a category of feedback. For example, a category of feedback may be “familiar person”, and user feedback indicating that the user interacted with a simulated phishing message because they believed they recognized the sender of the message, or they believe they recognized another recipient of the message, or they believe they recognized a person that the message referred to, may all be categorized as “familiar person” user feedback.

According to some embodiments, security awareness and training platform 202 may include user feedback analytics engine 234. In an implementation, user feedback analytics engine 234 may be an application or a program for assessing user feedback to develop insights into why users interacted with simulated phishing communications. In some examples. User feedback analytics engine 234 may be configured to interact with user record storage 242. In an example, user feedback analytics engine 234 may be configured to interact with risk score storage 244. In an example, user feedback analytics engine 234 may be configured to interact with simulated phishing template storage 244. User feedback analytics engine may query one or more storages, such as but not limited to the storages just mentioned to determine attributes of the failing user (including the failing user's risk score in some examples) and/or characteristics of the simulated phishing template used to generate the simulated phishing communication that the user failed, in order to create associations between characteristics and attributes of the user or of the simulated attack presented to the user, and the feedback provided by the user as to why they interacted with the simulated phishing attack.

According to some embodiments, security awareness and training platform 202 may include template association engine 236. In an implementation, template association engine 236 may be an application or a program which may be configured to interact with one or more storages, such as simulated phishing templates storage 240, user record storage 242, feedback questions storage 248, risk score storage 244, or any other storage. Template association engine 236 may query one or more storages, such as but not limited to the storages just mentioned, the determine attributes and/or characteristics of the simulated phishing template used to generate the simulated phishing communication that the user failed, in order to create associations between characteristics and attributes of the template user to generate the simulated phishing attack presented to the user, and the feedback provided by the user as to why they interacted with the simulated phishing attack. In examples, associations between user feedback and/or categories of the user feedback with simulation phishing templates may be used to aid a system administrator in selecting templates for future simulated phishing campaigns for one or more users, for example based on user feedback provided by the one or more users after failing a simulated phishing attack with a template with one or more similar attributes and/or characteristics as the template used to generate the simulated phishing message that the user failed.

According to some embodiments, security awareness and training platform 202 may include recommendation engine 238. In an implementation, recommendation engine 238 may be an application or a program which may be configured to provide to a system administrator or other user, recommendations of templates that might be successful in targeting security awareness shortcomings of a user that are relevant to user feedback, where the recommended templates are likely to be effective for testing these shortcomings based on associations between user feedback and the suggested templates. In an example, recommendation engine 238 may select one or more simulated phishing templates for future simulated phishing campaigns that target security awareness shortcomings and that are recognized as being effective for testing these shortcomings. Recommendation engine 238 may be configured to interact with simulated phishing template storage 240, user record storage 242, risk score storage 244, feedback questions storage 248, or any other storage or memory of security awareness and training platform 202.

In an implementation, risk score calculator 226, landing page generator 228, user feedback requestor 230, user feedback categorization engine 232, user feedback analytics engine 234, template association engine 236, and recommendation engine 238, amongst other units, may include routines, programs, objects, components, data structures, etc., which may perform particular tasks or implement particular abstract data types. In examples, risk score calculator 226, landing page generator 228, user feedback requestor 230, user feedback categorization engine 232, user feedback analytics engine 234, template association engine 236, and recommendation engine 238 may also be implemented as signal processor(s), state machine(s), logic circuitries, and/or any other device or component that manipulate signals based on operational instructions.

In some embodiments, risk score calculator 226, landing page generator 228, user feedback requestor 230, user feedback categorization engine 232, user feedback analytics engine 234, template association engine 236, and recommendation engine 238 may be implemented in hardware, instructions executed by a processing module, or by a combination thereof. In examples, the processing module may be main processor 121, as shown in FIG. 1D. The processing module may comprise a computer, a processor, a state machine, a logic array, or any other suitable devices capable of processing instructions. The processing module may be a general-purpose processor which executes instructions to cause the general-purpose processor to perform the required tasks or, the processing module may be dedicated to performing the required functions. In some embodiments, risk score calculator 226, landing page generator 228, user feedback requestor 230, user feedback categorization engine 232, user feedback analytics engine 234, template association engine 236, and recommendation engine 238 may be machine-readable instructions which, when executed by a processor/processing module, perform intended functionalities of risk score calculator 226, landing page generator 228, user feedback requestor 230, user feedback categorization engine 232, user feedback analytics engine 234, template association engine 236, and recommendation engine 238. The machine-readable instructions may be stored on an electronic memory device, hard disk, optical disk, or other machine-readable storage medium or non-transitory medium. In an implementation, the machine-readable instructions may also be downloaded to the storage medium via a network connection.

In some embodiments, security awareness and training platform 202 may include simulated phishing template storage 240, user record storage 242, risk score storage 244, landing page storage 246, and feedback questions storage 248. In an implementation, simulated phishing template storage 240 may store simulated phishing templates. In examples, a simulated phishing template which may be customized by a system administrator may be stored in simulated phishing template storage 240 such that the simulated phishing template can be used for multiple different users in the organization over a period of time or for different campaigns. In some examples, the system administrator may select a simulated phishing template from a pool of available simulated phishing templates stored in simulated phishing template storage 240 and may send a “stock” template to users unchanged.

In an implementation, user record storage 242 may store one or more attributes and/or one or more contextual parameters for each user of an organization. A contextual parameter for a user may include information associated with the user that may be used to make a simulated phishing communication more relevant to that user. In an example, one or more contextual parameters for a user may include one or more of the following —language spoken by the user, locale of the user, temporal changes (for example, time at which the user changes the locale), job title of the user, job department of the user, religious belief of the user, topics of communication the user engages in, subjects of communication the user engages in, a name of a manager or subordinate of the user, an industry applicable to the user (for example the industry associated with the user's employer), one or more addresses of the user (for example, Zip Code and street of the user's primary residence, secondary residence, place or work, place of education, residence of a family member of the user, etc.), a name or nickname of the user, subscriptions associated with the user, preferences demonstrated by the user, for example through selections or choices made by the user, the user's recent web browsing history, commercial transaction history, or recent communications of the user with one or more peers/manager/human resource partners/banking partner, a regional currency and units used by the user, and any other information associated with the user.

In some examples, simulated phishing template storage 240 may store failure rate data for one or more simulated phishing templates. In examples, the failure rate data may refer to data pertaining to failure rates associated with the template (e.g., a number of users that fail a simulated phishing test based on the template of all users that receive a simulated phishing test based on the template). Further, risk score storage 244 may store risk scores of users of an organization. A risk score of a user may be a representation or quantification of a cybersecurity risk that the user poses to an organization. In examples, a risk score of a user may be a representation of vulnerability of the user to a malicious attack. In one example, a user with a higher risk score may present a greater risk to the organization and a user with a lower risk score may present a lower risk to the organization.

In an implementation, landing page storage 246 may store landing page templates. Landing page templates my be one or more web pages or websites that get presented to a user if the user interacts with a simulated phishing message. In examples, landing page templates may be configured to include dynamic elements which will be adapted to the user the template is presented to. For example, a landing page template may have a field for a user's name and a user's email address, and when the landing page template is presented to the user, the user's actual name and email address are included on the landing page. A landing page may be used to provide security awareness training to a user that fails a simulated phishing test at the moment of the failure, or in examples a landing page may redirect a user that fails a simulated phishing test to another web address or location or server, where the user may be required to enroll in security awareness training that may be delivered at a different time and using a different mechanism, that is asynchronously with the failure itself.

In an implementation, feedback questions storage 248 stores a plurality of user feedback questions. From which one or more feedback questions may be selected to form the collection of feedback questions that may be presented to a user. In an example, the user feedback questions may be a set of one or more questions which gather feedback from one or more users when the one or more users fail a simulated phishing test. In examples, a system administrator or other user that is configuring a simulated phishing campaign may choose user feedback questions to be presented to the users that fail the campaign. In examples, feedback questions storage may be configured to interact with a user interface device, such as one or more of I/O devices 126, 127, and 130 a-n. In some examples, one or more of the user feedback questions may be prepopulated with candidate answers. In an example, one or more user feedback questions may be associated to a simulated phishing template or to a simulated phishing communication based on the simulated phishing template. In examples, one or more user feedback questions may solicit responses from a user to the questions in response to the user interacting with a simulated phishing communication. Examples of user feedback questions which may be stored in feedback questions storage 248 include, but are not limited to, “Why did you interact with the message?”, “Were you suspicious of this message?”, “Did you assess this message for exploits or threats?”, “Did you consider reporting this message?”, and “Did you identify that the message came from a domain outside of our organization?”. In examples, a user feedback question may be accompanied by one or more standard responses, from which a user may select one or more of the responses, where the one or more standards responses are configured to be presented as candidate answers to the user feedback question. In an implementation, feedback questions storage 248 may also store standard responses corresponding to one or more user feedback questions. In examples, one or more user feedback questions may be configured by a system administrator, a security authority, or other agents. In examples, a user, a system administrator, a security authority, an AI agent, or any other agent may create one or more user feedback questions and may store the one or more user feedback questions in feedback questions storage 248. In examples, a user, a system administrator, a security authority, an AI agent, or any other agent may remove one or more user feedback questions from feedback questions storage 248, for example if the one or more user feedback questions have been used for a period of time and have been shown to be less effective in soliciting user feedback useful for making associations. In examples, the simulated phishing templates stored in simulated phishing template storage 240, one or more contextual parameters for the users stored in user record storage 242, one or more risk scores of the users stored in risk score storage 244, one or more of the landing page templates stored in landing page storage 246, and one or more of the user feedback questions stored in feedback questions storage 248 may be periodically or dynamically updated as required.

Referring again to FIG. 2, in one or more embodiments, user device 204-(1-N) may be any device used by a user (all devices of user device 204-(1-N) are subsequently referred to as user device 204-1 however, the description may be generalized to any of user device 204-(1-N)). The user may be an employee of an organization, a client, a vendor, a customer, a contractor, a system administrator, or any person associated with the organization. User device 204-1 may be any computing device, such as a desktop computer, a laptop, a tablet computer, a mobile device, a Personal Digital Assistant (PDA), or any other computing device. In an implementation, user device 204-1 may be a device, such as client device 102 shown in FIG. 1A and FIG. 1B. User device 204-1 may be implemented by a device, such as computing device 100 shown in FIG. 1C and FIG. 1D. According to some embodiments, user device 204-1 may include processor 256-1 and memory 258-1. In an example, processor 256-1 and memory 258-1 of user device 204-1 may be CPU 121 and main memory 122, respectively, as shown in FIG. 1C and FIG. 1D. User device 204-1 may also include user interface 260-1, such as a keyboard, a mouse, a touch screen, a haptic sensor, a voice-based input unit, or any other appropriate user interface. It shall be appreciated that such components of user device 204-1 may correspond to similar components of computing device 100 in FIG. 1C and FIG. 1D, such as keyboard 126, pointing device 127, I/O devices 130a-n and display devices 124a-n. User device 204-1 may also include display 262-1, such as a screen, a monitor connected to the device in any manner, or any other appropriate display, which may correspond to similar components of computing device 100, for example display devices 124a-n. In an implementation, user device 204-1 may display received content (for example, a simulated phishing communication based on a simulated phishing template) for the user using display 262-1 and is able to accept user interaction via user interface 260-1 responsive to the displayed content.

Referring again to FIG. 2, in some embodiments, user device 204-1 may include email client 264-1. In one example, email client 264-1 may be a cloud-based application that can be accessed over network 250 without being installed on user device 204-1. In an implementation, email client 264-1 may be any application capable of composing, sending, receiving, and reading email messages. In an example, email client 264-1 may facilitate a user to create, receive, organize, and otherwise manage email messages. In an implementation, email client 264-1 may be an application that runs on user device 204-1. In some implementations, email client 264-1 may be an application that runs on a remote server or on a cloud implementation and is accessed by a web browser. For example, email client 264-1 may be an instance of an application that allows viewing of a desired message type, such as any web browser, Microsoft Outlook™ application (Microsoft, Mountain View, California), B3M® Lotus Notes® application, Apple® Mail application, Gmail® application (Google, Mountain View, California), WhatsApp™ (Facebook, Menlo Park, California), a text messaging application, or any other known or custom email application. In an example, a user of user device 204-1 may be mandated to download and install email client 264-1 on user device 204-1 by the organization. In an example, email client 264-1 may be provided by the organization as default. In some examples, a user of user device 204-1 may select, purchase and/or download email client 264-1 through an application distribution platform. In some examples, user device 204-1 may receive simulated phishing communications via email client 264-1. Other user devices 204-(2-N) may be similar to user device 204-1.

In one or more embodiments, email client 264-1 may include email client plug-in 266-1. An email client plug-in may be an application or program that may be added to an email client for providing one or more additional features or customizations to existing features. The email client plug-in may be provided by the same entity that provides the email client software or may be provided by a different entity. In an example, email client plug-in may provide a User Interface (UI) element such as a button to enable a user to trigger a function. Functionality of client-side plug-ins that use a UI button may be triggered when a user clicks the button. Some examples of client-side plug-ins that use a button UI include, but are not limited to, a Phish Alert Button (PAB) plug-in, a task create plug-in, a spam marking plug-in, an instant message plug-in, a social media reporting plug-in and a search and highlight plug-in. In an embodiment, email client plug-in 266-1 may be any of the aforementioned types or may be of any other type.

In some implementations, email client plug-in 266-1 may not be implemented in email client 264-1 but may coordinate and communicate with email client 264-1. In some implementations, email client plug-in 266-1 is an interface local to email client 264-1 that supports email client users. In one or more embodiments, email client plug-in 266-1 may be an application that supports the user, i.e., recipients of simulated phishing communications, to select to report suspicious simulated phishing communications that they believe may be a threat to them or their organization. Other implementations of email client plug-in 266-1 not discussed here are contemplated herein. In one example, email client plug-in 266-1 may provide the PAB plug-in through which functions or capabilities of email client plug-in 266-1 are triggered/activated by a user action on the button. Upon activation, email client plug-in 266-1 may forward content (for example, suspicious simulated phishing communications) to a system administrator. In some embodiments, email client plug-in 266-1 may cause email client 264-1 to forward content to the system administrator, or an Incident Response (IR) team of the organization for threat triage or threat identification. In some embodiments, email client 264-1 or email client plug-in 266-1 may send a notification to security awareness and training platform 202 that a user has reported content received at email client 264-1 as potentially malicious. Thus, in examples, the PAB plug-in button enables a user to report suspicious content.

Referring back to FIG. 2, in some embodiments, threat reporting platform 206 may be a platform that enables the user to report message(s) that the user finds to be suspicious or believes to be malicious, through email client plug-in 266-1 or any other suitable means. In some examples, threat reporting platform 206 may be configured to manage a deployment of and interactions with email client plug-in 266-1, allowing the user to report the suspicious messages directly from email client 264-1. In some example implementations, threat reporting platform 206 may be configured to analyze a reported message to determine whether the reported message is a simulated phishing communication.

In some embodiments, threat detection platform 208 may be a platform that monitors, identifies, and manages cybersecurity attacks including phishing attacks faced by the organization or by users within the organization. In some embodiments, threat detection platform 208 may be configured to analyze messages that are reported by users to detect any cybersecurity attacks such as phishing attacks via malicious messages. A malicious message may be a message that is designed to trick a user into causing the download of malicious software (for example, viruses, Trojan horses, spyware, or worms) that is of malicious intent onto a computer. The malicious message may include malicious elements. A malicious element is an aspect of the malicious message that, when interacted with, downloads or installs malware onto a computer. Examples of a malicious element include a URL or link, an attachment, and a macro. The interactions may include clicking on a link, hovering over a link, copying a link, and pasting it into a browser, opening an attachment, downloading an attachment, saving an attachment, attaching an attachment to a new message, creating a copy of an attachment, executing an attachment (where the attachment is an executable file), and running a macro. The malware (also known as malicious software) is any software that is used to disrupt computer operations, gather sensitive information, or gain access to private computer systems. Examples of malicious messages include phishing messages, smishing messages, vishing messages, malicious IM, or any other electronic message designed to disrupt computer operations, gather sensitive information, or gain access to private computer systems. Threat detection platform 208 may use information collected from identified cybersecurity attacks and analyze messages to prevent further cybersecurity attacks.

Referring back to FIG. 2, in some embodiments, administrator device 210 may be any device used by a user or a system administrator or a security administrator to perform administrative duties. Administrator device 210 may be any computing device, such as a desktop computer, a laptop, a tablet computer, a mobile device, a Personal Digital Assistant (PDA), smart glasses, or any other computing device. In an implementation, administrator device 210 may be a device, such as client device 102 shown in FIG. 1A and FIG. 1B. Administrator device 210 may be implemented by a device, such as computing device 100 shown in FIG. 1C and FIG. 1D.

According to an implementation, security awareness and training platform 202 may initiate a simulated phishing campaign based on communicating one or more simulated phishing communications to users of the organization. Upon receiving the one or more simulated phishing communications, one or more users may interact with the one or more simulated phishing communications. In examples, a user may interact with a simulated phishing communication in many ways. Examples of the interaction include, but are not limited to, clicking on a link within the simulated phishing communication where the address is visible, clicking on a link within the simulated phishing communication where the address is not visible, opening an attachment, running executable code within the simulated phishing communication, forwarding the simulated phishing communication to an address within the organization of which the user is a part, forwarding the simulated phishing communication to an address outside of the organization of which the user is a part, deleting the simulated phishing communication without reading, deleting the simulated phishing communication after opening and reading, reporting the simulated phishing communication without reading, and reporting the simulated phishing communication after opening and reading.

According to an embodiment, user feedback requestor 230 may obtain or receive feedback from the one or more users that interacted with the one or more simulated phishing communications, the feedback identifying one or more reasons that the one or more users interacted with the one or more simulated phishing communications. In an implementation, user feedback requestor 230 may cause a prompt requesting feedback from the one or more users responsive to the one or more users interacting with the one or more simulated phishing communications.

According to an implementation, user feedback requestor 230 may obtain the feedback from the one or more users upon receiving a request (or an input) from a system administrator. In examples, the system administrator may decide on a campaign-by-campaign basis, a message-by-message basis, or a combination of both (for example, a specific simulated phishing communication in a simulated phishing campaign may be configured with a different requirement to the rest of the simulated phishing campaign) whether to gather user feedback and how to gather user feedback. In an example, when configuring a simulated phishing campaign or a simulated phishing template that can be used to generate simulated phishing messages, the system administrator may check a checkbox which enables a user feedback requestor feature, or the system administrator may select, via other UI mechanisms such as a drop-down list or a set of more detailed checkboxes, the type of user feedback required. In an implementation, the user feedback that is requested may be the same in all cases of user interaction, which is regardless of how the user interacts with a simulated phishing message, the user feedback that is requested is the same. In some implementations, the user feedback that is requested if the user interacts with a simulated phishing message may be defined by the system administrator for each example of user interaction. For example, a user that clicks on a simulated phishing message may be provided with a different request for user feedback than a user that forwards a simulated phishing message to another user. In an example, different user feedback may be requested from each configured simulated phishing communication. That is, there may be an associated between one or more types of user feedback requests and a given simulated phishing template from which one or more simulated phishing communications may be generated, or there may be an association between a generated simulated phishing communication and one or more types of user feedback requests.

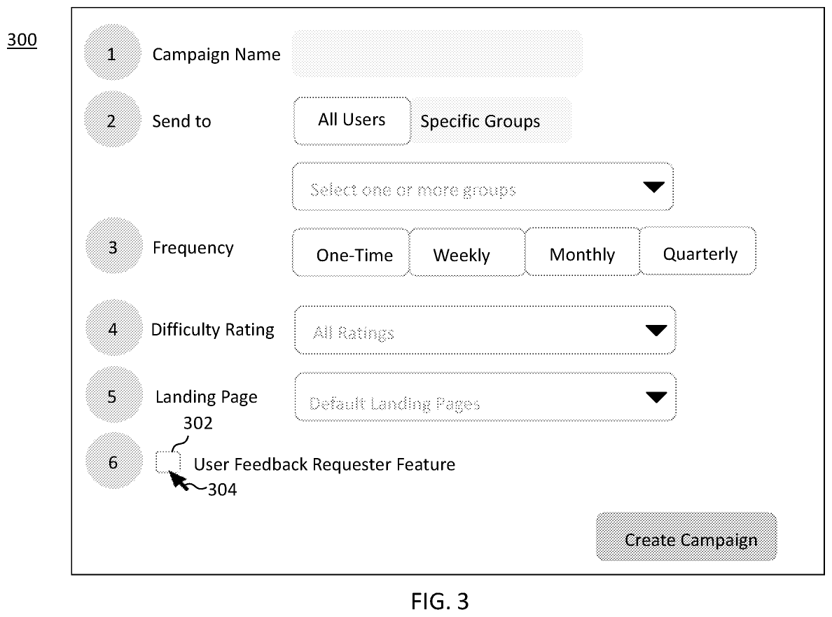

FIG. 3 depicts example 300 of a user interface that a user such as a system administrator may use to configure a simulated phishing campaign. User interface of example 300 illustrates a method of enabling a user feedback requester feature by a system administrator as a part of a configuration of a simulated phishing campaign, according to some embodiments. As shown in FIG. 3, while configuring a simulated phishing campaign, the system administrator may check (or click on) checkbox 302, for example using mouse pointer 304, to enable the user feedback requestor feature, for example for one or more simulated phishing communications of the simulated phishing campaign, or for all simulated phishing communications of the simulated phishing campaign. In an implementation, while configuring a simulated phishing campaign, a system administrator may select a simulated phishing template on which one or more simulated phishing communications will be based and sent to users. In an example, as a result of enablement of the user feedback requester feature, when the users interact with the one or more simulated phishing communications, feedback may be sought from the users to request information about the reasons why the user interacted with one or more simulated phishing communications.

In examples, the one or more users that interacted with one or more simulated phishing communications may be provided one or more user feedback questions. In an implementation, the system administrator may define the user feedback questions, for example when the system administrator configured a simulated phishing campaign or configured a simulated phishing template of a simulated phishing campaign. Examples of user feedback questions include, but are not limited to, “Why did you interact with the message?”, “Were you suspicious of this message?”, “Did you assess this message for exploits?”, “Did you consider reporting this message?”, and “Did you identify that the message came from a domain outside of our organization?”.

In an implementation, user feedback requestor 230 may receive the feedback in response to the feedback questions configured by a system administrator in the form of responses selected by the one or more users from a predetermined set of responses. In an example, when configuring a simulated phishing campaign or a simulated phishing template of a simulated phishing campaign, a system administrator that selects a user feedback question may selected one or more predetermined responses to be presented to the user with the feedback questions, such that the user has a number of predetermined (which may also be referred to as “standard”) responses from which a user may select one or more to be presented as answers to the user feedback question. In examples, the user feedback questions that may be configured with standard responses may include “Were you suspicious of this message?,” “Did you assess this message for exploits?” and “Did you consider reporting this message?.” In an example, the user feedback question “Why did you interact with the message?” may be accompanied by standard responses such as “I knew and trusted the sender”, “I was expecting an email like this one”, “The message looked interesting to me”, “I was distracted and did not think”, “It did not occur to me not to”, “The email was similar to one I receive regularly”, “It appeared urgent”, “It felt important to respond”, “I do not remember this email”, “I was cleaning out my inbox”, and “It appeared to come from a senior manager”.

In some examples, user feedback questions included in a simulated phishing campaign or in a simulated phishing template of a simulated phishing campaign may relate or correspond to the exploits included within the simulated phishing communication. Examples of such user feedback questions include “Did you notice that the URL (in this message) was directed outside of the organization?”, “Did you identify that the message came from a domain outside of our organization?”, “Did you notice any spelling mistakes in the message?”, and “Did you attempt to verify the authenticity of the message?”. In examples, user feedback questions that correspond to exploits included within a simulated phishing communication that the user interacted with may solicit Yes/No responses from a user that interacted with the simulated phishing communication.

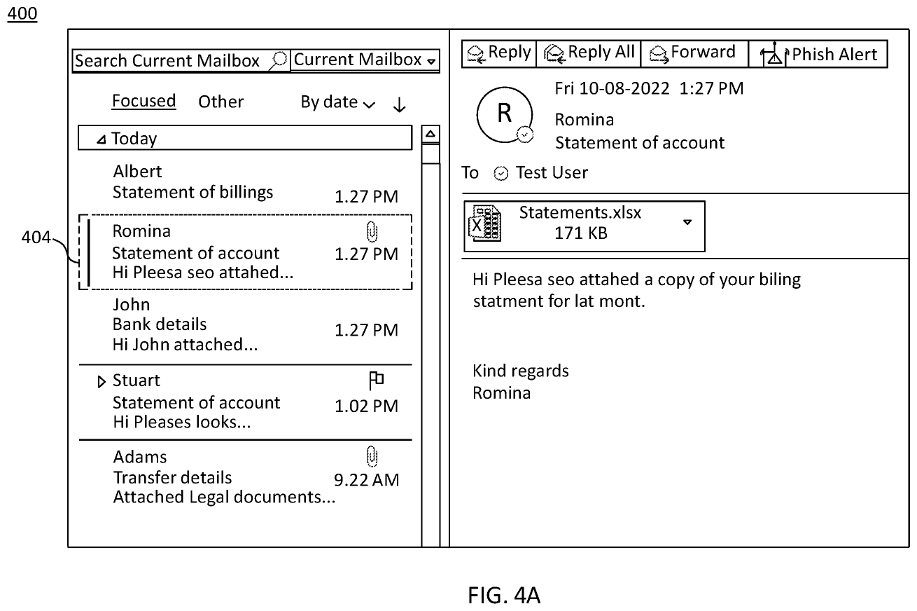

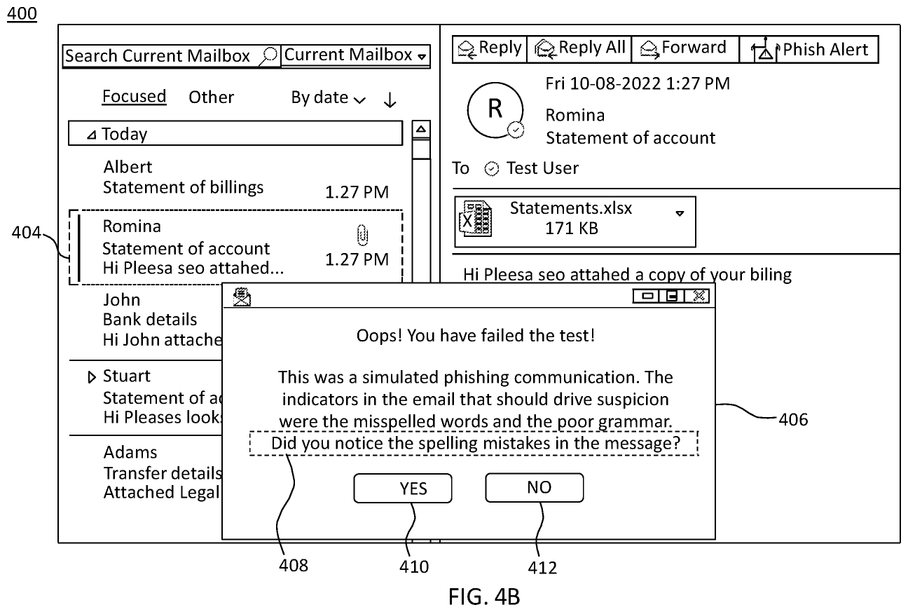

FIG. 4A illustrates example 400 of simulated phishing communication 404 (which is shown in this example as an email) received by a user, according to some embodiments. In the example of FIG. 4A, simulated phishing communication 404 with subject “Statement of account” is shown to include an Excel file as an attachment. In an example, simulated phishing communication 404 may appear genuine to the user and may entice the user to interact with it. In an example, the user may interact with simulated phishing communication 404 by attempting to open the attachment, for example by double clicking on the attachment or by clicking on the pulldown arrow beside the attachment name and using the menus to select “open”.

FIG. 4B is a continuation of FIG. 4A. FIG. 4B illustrates an example of user feedback question 408 rendered to the user responsive to the user interacting with simulated phishing communication 404, according to some embodiments. In the example shown in FIG. 4B, simulated phishing communication 404 includes misspelled words and poor grammar. However, the user may not notice the misspelled words and poor grammar of simulated phishing communication 404, and the user may attempt to open the attachment in simulated phishing communication 404. If the user interacts with simulated phishing communication 404, a pop-up message 406 including user feedback question 408 may be displayed to the user. As can be seen in FIG. 4B, pop-up message 406 reads “Oops! You have failed the test! This was a simulated phishing communication. The indicators in the email that should drive suspicion were the misspelled words and the poor grammar.” The pop-up message 406 includes user feedback question 408 “Did you notice the spelling mistakes in the message?”. In examples, user feedback question 408 may solicit Yes/No responses (feedback) from the user to user feedback question 408. In an example, the user may click either on YES button (410) or NO button (412) in response to the user feedback question 408. The user's response (either Yes or No) may be recorded as the user feedback.

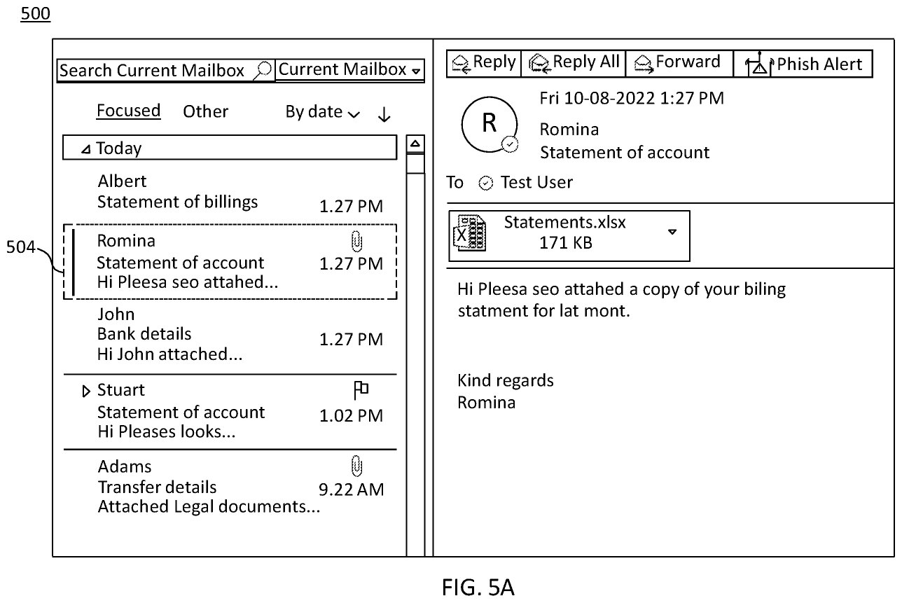

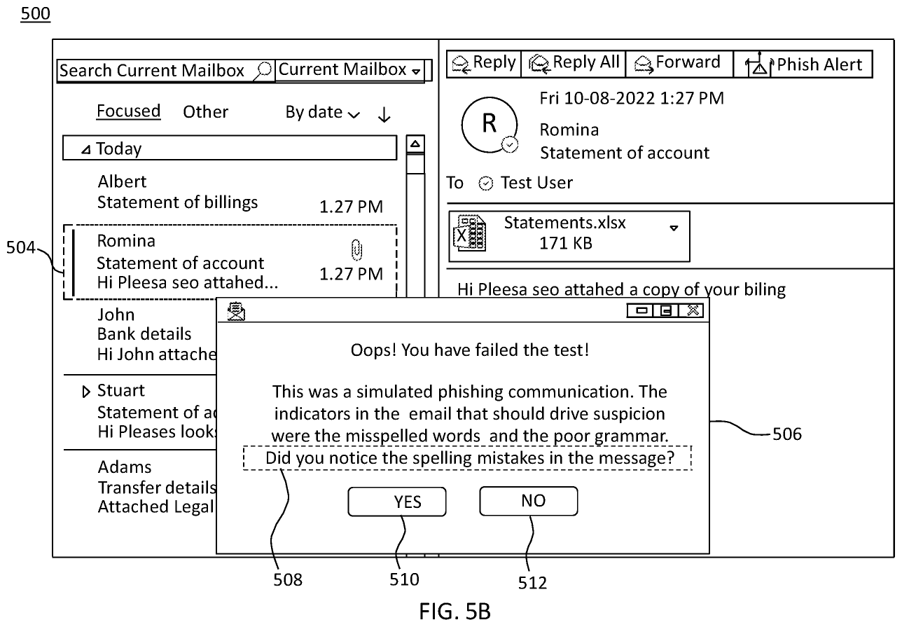

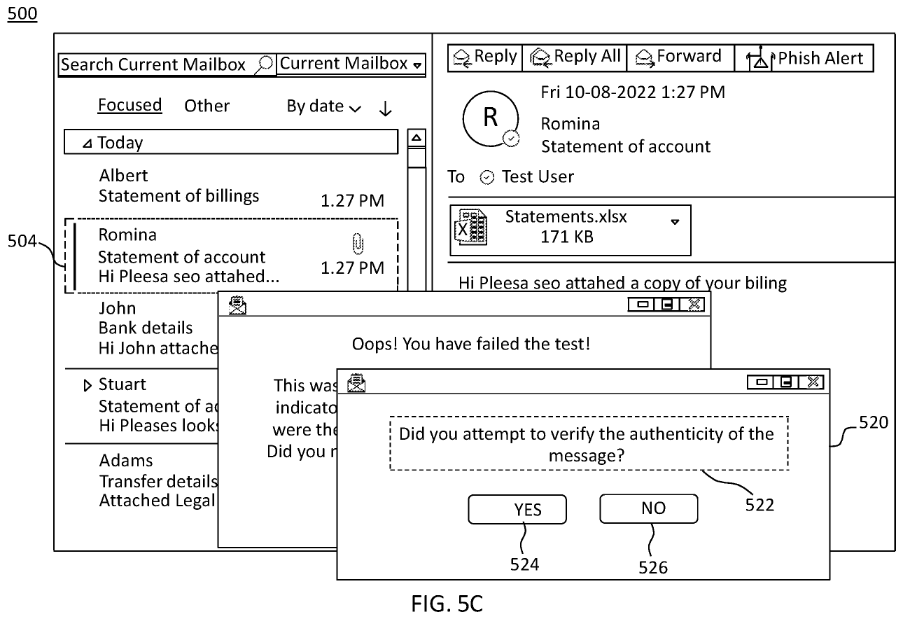

FIG. 5A illustrates example 500 of simulated phishing communication 504 received by a user, according to some embodiments. In the example of FIG. 5A, simulated phishing communication 504 with subject “Statement of account” is shown to include an Excel file as an attachment. In an example, simulated phishing communication 504 may appear genuine to the user and may entice the user to interact with it. In an example, the user may interact with simulated phishing communication 504 by opening the attachment.

FIG. 5B and FIG. 5C illustrate examples 500 of a series of user feedback questions (508, 522) rendered to the user responsive to the user interacting with simulated phishing communication 504, according to some embodiments. FIG. 5B is a continuation of FIG. 5A, and FIG. 5C is a continuation of FIG. 5B.

In the example shown in FIG. 5B, simulated phishing communication 504 includes misspelled words and poor grammar. However, the user may not notice the misspelled words and poor grammar of simulated phishing communication 504, and the user may attempt to open the attachment in simulated phishing communication 504. If the user interacts with simulated phishing communication 504, a pop-up message 506 including user feedback question 508 may be displayed to the user. As can be seen in FIG. 5B, pop-up message 506 reads “Oops! You have failed the test! This was a simulated phishing communication. The indicators in the email that should drive suspicion were the misspelled words and the poor grammar.” The pop-up message 506 includes user feedback question 508 “Did you notice the spelling mistakes in the message?”. In examples, user feedback question 508 may solicit Yes/No responses (feedback) from the user to user feedback question 508. In an example, the user may click either on YES button (510) or NO button (512) in response to the user feedback question 508. The user's response (either Yes or No) may be recorded as the user feedback. Further, after the user provides the response (for example, by clicking on either YES button (510) or NO button (512)), another pop-up message 520 including user feedback question 522 may be displayed to the user (as shown in FIG. 5C).

As can be seen in FIG. 5C, pop-up message 520 includes user feedback question 522 “Did you attempt to verify the authenticity of the message?”. In examples, user feedback question 522 may solicit Yes/No responses (feedback) from the user to user feedback question 522. In an example, the user may click either on YES button (524) or NO button (526) in response to the user feedback question 522. The user's response (either Yes or No) may be recorded as the user feedback.

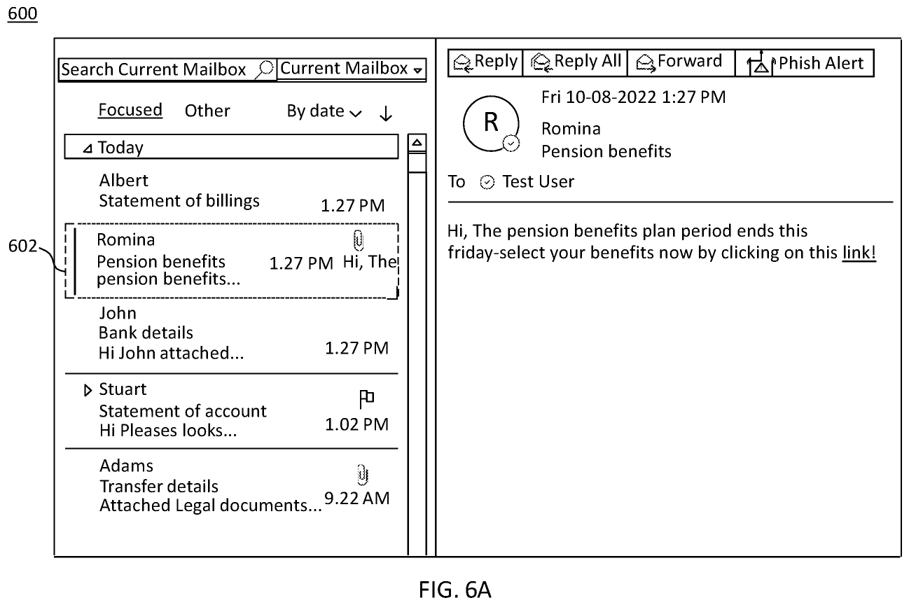

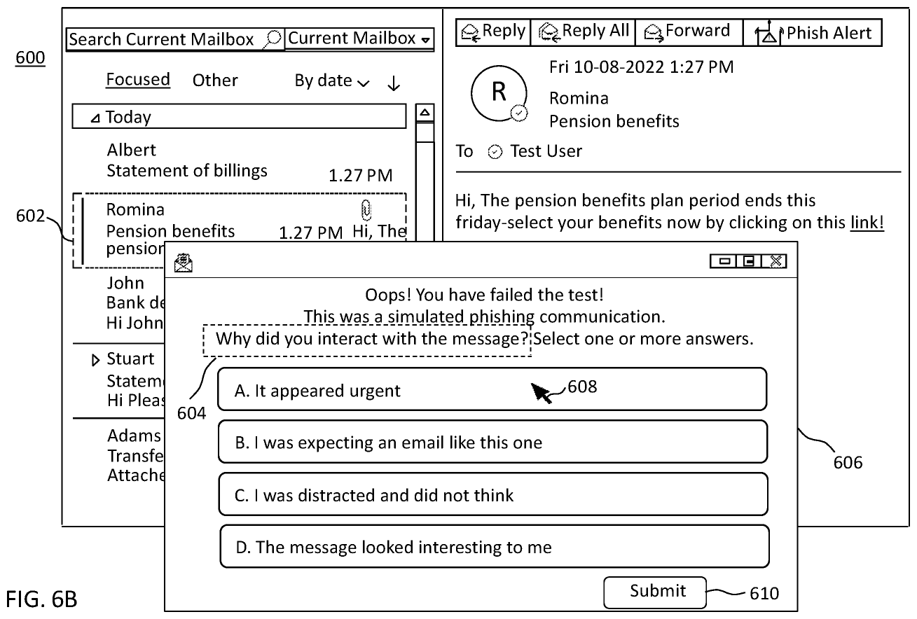

FIG. 6A illustrates an example of simulated phishing communication 602 (which is shown in this example as an email) received by a user, according to some embodiments. In the example of FIG. 6A, simulated phishing communication 602 with subject “Pension Benefits” is shown. Simulated phishing communication 602 includes a message “The pension benefits plan period ends this Friday—select your benefits now by clicking on this link!”. The urgency in tone of the message may entice the user to interact with it. In an example, the user may interact with simulated phishing communication 602 by clicking on the displayed link.

FIG. 6B illustrates example 600 of user feedback question 604 accompanied by a selectable list of standard or predetermined responses rendered to the user responsive to the user interacting with simulated phishing communication 602, according to some embodiments. In an example, the user may interact with simulated phishing communication 602 by clicking on the link. If the user interacts with simulated phishing communication 602, pop-up message 606 including user feedback question 604 may be displayed to the user. As can be seen in FIG. 6B, pop-up message 606 reads “Oops! You have failed the test! This was a simulated phishing communication.” The pop-up message 606 includes user feedback question 604 “Why did you interact with the message?”. In examples, user feedback question 604 may be accompanied by one or more responses from which a user may select to be presented as candidate answers to user feedback question 604. In the example of FIG. 6B, four responses are shown, the examples responses include “It appeared urgent”, “I was expecting an email like this one”, “I was distracted and did not think”, and “The message looked interesting to me”. In an example, the user may select one or more responses in response to the user feedback question 604. The user's response may be recorded as the user feedback. Further, after selecting the one or more responses, the user may submit the response by clicking on submit button 610.

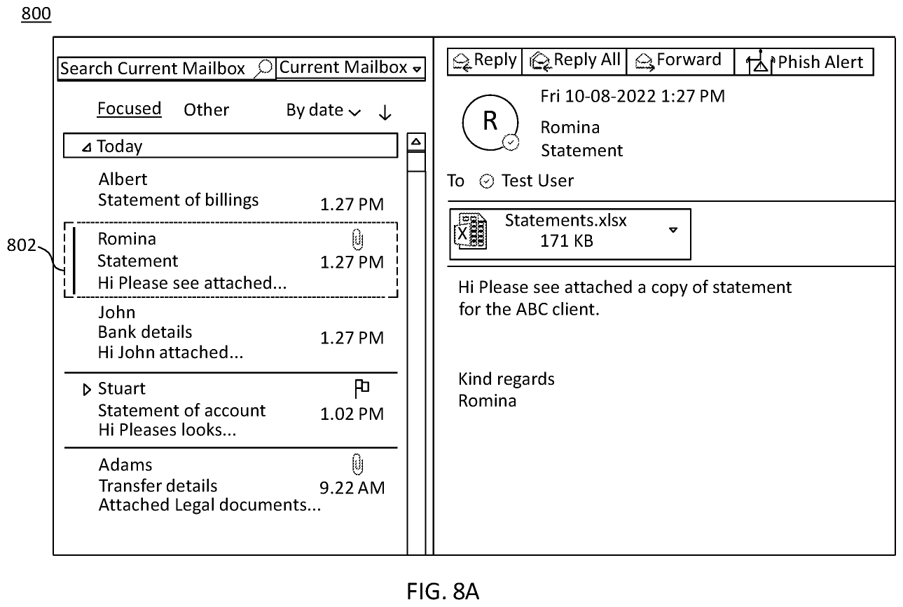

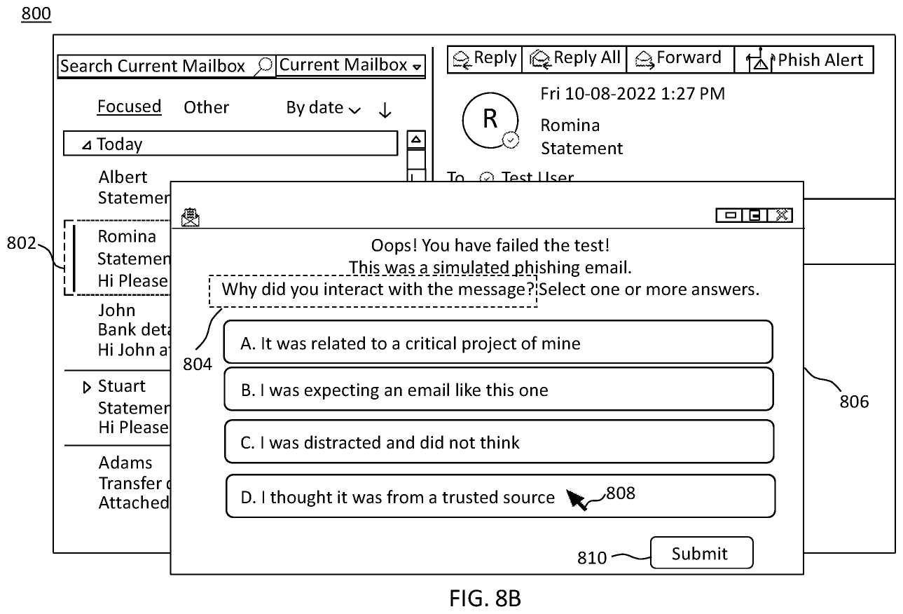

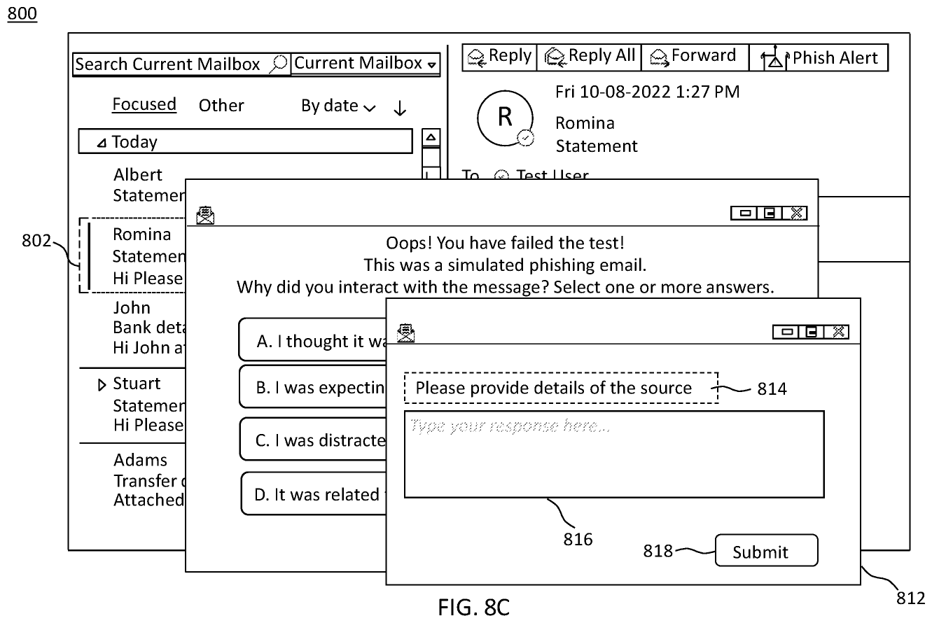

In examples, specific user feedback questions may solicit freeform responses from the user. In such cases, a text box for a written answer may be provided to the user, for example text box 816 of FIG. 8C. For instance, in the event that a user interacts with a link within a simulated phishing communication, the user may be prompted to input, via a text box or other input medium, a written answer indicating why the user interacted with the link. The text box may be presented to the user in isolation as a single means for inputting feedback or may be presented alongside a menu of responses for the purpose of capturing the user feedback. In some examples, audio or video feedback may be sought from the user. In an implementation, user feedback questions and/or responses (answers) to the user feedback questions may be stored within feedback questions storage 248 or may be stored in user record storage 242 in a record for the particular user. In an example, sone or all of written feedback from one or more users may be presented to a system administrator as an option from which to generate a user feedback request option for use in one or more subsequent simulated phishing campaign. In examples, the user feedback questions and/or the answers to the user feedback questions may be made available more widely to other system administrators (e.g., system administrators of other organizations), for example as a part of a set of default options presented to them. For instance, a system administrator may opt for receiving recommendations for user feedback questions by subscribing to receive or to automatically implement the user feedback questions used by a specific system administrator or a group of system administrators.

In some embodiments, user feedback may be solicited through a form that is presented to the user of the user interacts with a simulated phishing communication, where user feedback has been requested for that simulated phishing communication (either directly or as part of the simulated phishing campaign that the simulated phishing message is included in). The form may be a user feedback web form in HTML, JavaScript, or any other web-based language or combination of languages. In an example, the form may be presented prior to any other pre-determined actions that the system administrator requires of the simulated phishing campaign. For example, if the system administrator requires that a landing page with representative training material is to be presented, then user feedback may be sought in a user feedback web form which is presented before the training material (i.e., the landing page) is presented to the user. In an example, after feedback has been provided, the user is presented with the landing page. In some embodiments, user feedback may be sought and provided through a user feedback email form that is sent to the user by an email after user interaction with a simulated phishing communication, or directly injected into the user's mailbox by security awareness and training platform 202. In examples, a user feedback email form may be more suited to some user interactions than others. For example, if a user deletes a simulated phishing communication without reading the simulated phishing communication, then there may not be an opportunity to present a user feedback web form, and therefore a user feedback email form sent to the user and triggered by the action of deleting the simulated phishing communication as detected by the email platform (for example, Microsoft Office 365, Microsoft Exchange) or a plug-in to the email platform, may be more appropriate. A user feedback email form may also be appropriate if a user opens an attachment or enters sensitive data, such as his or her username and password into a landing page.

In some examples, user feedback may also be sought and provided during user security awareness training. According to an implementation, user feedback requestor 230 may receive additional feedback from one or more users responsive to security awareness training provided to the one or more users. In some cases, interaction with a simulated phishing communication may lead to security awareness training, during which the user feedback as requested and configured by the system administrator may be gathered. In an implementation, a user who interacts with a simulated phishing communication is immediately provided with training on phishing attacks. In an implementation, on receiving the simulated phishing communication, if a user interacts with the one or more benign elements of the simulated phishing communication in any way, the user may be traversed to (or presented with) a specific landing page. For example, the user may be traversed to the landing page if the user clicks on one or more benign links in the simulated phishing communication or on a benign link in an attachment of the simulated phishing communication. In some implementations, the link may include the landing page that embeds a copy of the simulated phishing communication. In examples, the copy of the simulated phishing communication may include one or more flags at a site of malicious traps, such as Uniform Resource Locators (URLs). The landing page may alert the user that the user has failed a simulated phishing test and provide general or specific learning materials to the user.

In examples, the user feedback may be gathered by a user feedback web form which is generated automatically based on configuration options chosen by the system administrator during the configuration of the simulated phishing campaign. The user feedback web form may be presented automatically by user feedback requestor 230 during the security awareness training. Other media for gathering user feedback may also be used, such as short message service (SMS), instant messaging (IM), or automated voice call with preprogrammed answers access via a dual tone multi frequency (DTMF) feedback system. In an implementation, user feedback requestor 230 may also include a mechanism that allows a system administrator to request further information from a user regarding reasons for interacting with a simulated phishing communication after receiving the user's initial feedback (for example, by displaying follow up questions).

In an example, a user may click on a link displayed within a simulated phishing communication (for example, an email) and may be directed to a user feedback landing page. When user feedback is requested, the user may indicate for example that the sender of the simulated phishing communication appeared to belong to an organization with which the user is familiar and trusts. At this point, the system administrator may request the user to provide any specific characteristics of the simulated phishing communication that contributed to its perceived authenticity, for instance, its use of a similar color theme to that of the trusted organization, or its similarity to previous authentic emails received from said organization.

In some examples, a user may interact with a simulated phishing communication (for example, an email) and is directed to a user feedback landing page, where the user indicates that the user interacted with the simulated phishing communication because the user perceived it to have been sent by his or her manager. At this point, the system administrator may request the user to provide further details about his to her relationship with the manager, including, for instance, an indication of how long he or she has reported to the manager, the seniority of the manager, etc. In the event that the user did not interact with the simulated phishing communication, the user feedback requestor 230 may request user feedback after a specific period of time.

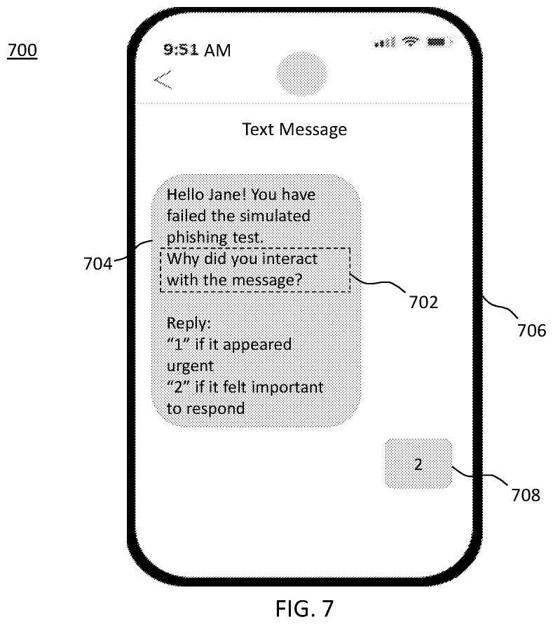

FIG. 7 illustrates example 700 of gathering response (feedback) to user feedback question 702 sent, via a messaging system (such as iMessage, WhatsApp, Facebook Messager, or SMS as non-limiting examples, referred to from this point as a message without any loss of generality) as shown in FIG. 7 as 704, to user device 706 (example of which is user device 204-1), according to some embodiments. In an example, user feedback question 702 may be accompanied with selectable answers. In an implementation, responsive to a user interacting with a simulated phishing communication, a feedback identifying a reason that the user interacted with simulated phishing communication may be sought from the user.

Referring to FIG. 7, in examples, message 704 including user feedback question 702 is sent to user device 706 when user of user device 706 interacts with a simulated phishing communication. As can be seen in FIG. 7, message 704 reads “Hello Jane! You have failed the simulated phishing test.” The message 704 includes user feedback question 702 “Why did you interact with the message?”. User feedback question 702 is accompanied by two standard responses from which the user may select to be presented as candidate answers to user feedback question 704 such as “Reply: “1” if it appeared urgent and “2” if it felt important to respond. In an example, the user may respond to user feedback question 704 by typing either “1” or “2”. In the example of FIG. 7, the user has responded by selecting option “2”, i.e., it felt important to respond (represented by reference numeral 708). The user's response may be recorded as the user feedback.

FIG. 8A illustrates example 800 of simulated phishing communication 802 (an email) received by a user, according to some embodiments.

In the example of FIG. 8A, simulated phishing communication 802 with subject “Statement” is shown to include an Excel file as an attachment. In an example, simulated phishing communication 802 may appear genuine to the user and may entice the user to interact with it. In an example, the user may interact with simulated phishing communication 802 by opening or attempting to open the attachment.

FIG. 8B is a continuation of FIG. 8A. FIG. 8B illustrates an example of user feedback question 804 rendered to the user responsive to the user interacting with simulated phishing communication 802, according to some embodiments.

In the example shown in FIG. 8B, simulated phishing communication 802 may be related to a client (i.e., ABC client) of the user. In an example, the user may open or attempt to open the attachment in simulated phishing communication 802. If the user interacts with simulated phishing communication 802, pop-up message 806 including user feedback question 804 may be displayed to the user. As can be seen in FIG. 8B, pop-up message 806 reads “Oops! You have failed the test! This was a simulated phishing communication.” The pop-up message 806 includes user feedback question 804 “Why did you interact with the message?”. In examples, user feedback question 804 may be accompanied by one or more responses (the example in FIG. 8B shows four responses) from which a user may select, the one or more responses to be presented as candidate answers to user feedback question 804. In the example of FIG. 8B, the four responses include “It was related to a critical project of mine”, “I was expecting an email like this one”, “I was distracted and did not think”, and “I thought it was from a trusted source”. In an example, the user may select one or more responses in response to the user feedback question 804. The user's response may be recorded as the user feedback. In the example shown in FIG. 8B, the user selects (for example, using mouse pointer 808) the response “I thought it was from a trusted source”. Further, after selecting the response, the user may submit the response by clicking on submit button 810. The user's response may be recorded as the user feedback. Further, after the user provides the response (for example, by clicking on submit button 810), another pop-up message 812 including follow up user feedback question 814 may be displayed to the user (as shown in FIG. 8C).

FIG. 8C is a continuation of FIG. 8B. FIG. 8C illustrates an example of follow up user feedback question 814 rendered to the user after receiving the user's initial feedback (i.e., response to user feedback question 804), according to some embodiments.

As can be seen in FIG. 8C, pop-up message 812 includes follow up user feedback question 814 “Please provide details of the source”. In examples, follow up user feedback question 814 may solicit freeform response from the user. In an example, text box 816 for a written answer may be provided to the user. In an example, the user may input in text box 816, for example the user may indicate that the user interacted with simulated phishing communication 802 because he or she perceived it to have been sent by his or her manager. The user may further provide further details about his or her relationship to the manager including, for instance, indication of how long the user have been reporting to the manager, the seniority of the manager, etc. Further, the user may submit the response by clicking on submit button 818. Where a user enters responses using freeform text, in examples, user feedback analytics engine 234 may parse the freeform user feedback, for example using Natural Language Processing (NLP) or a semantics analysis tool, or other methods of codifying freeform text into a finite set of responses, such as is known in the art.

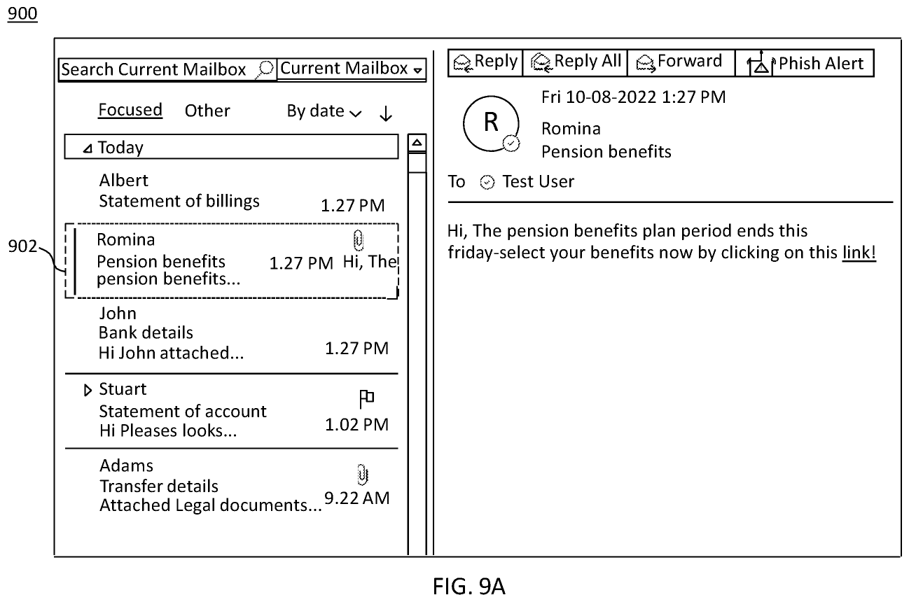

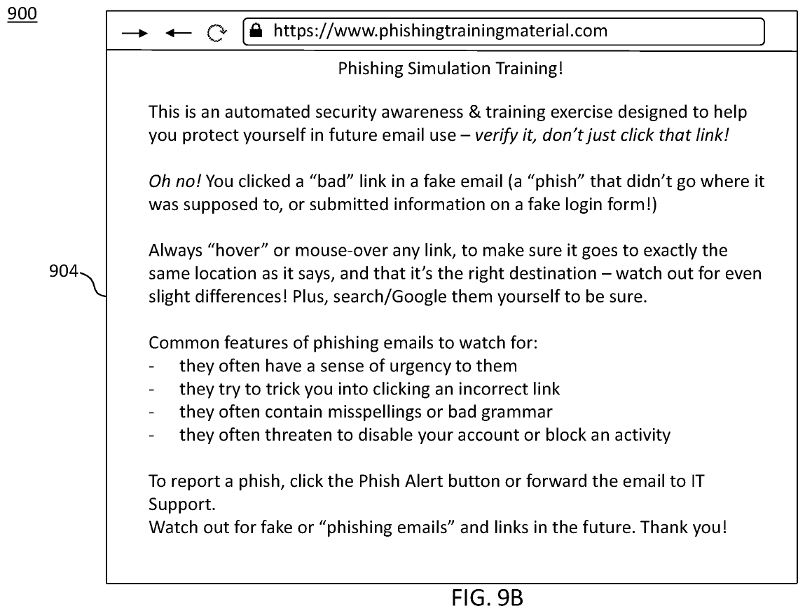

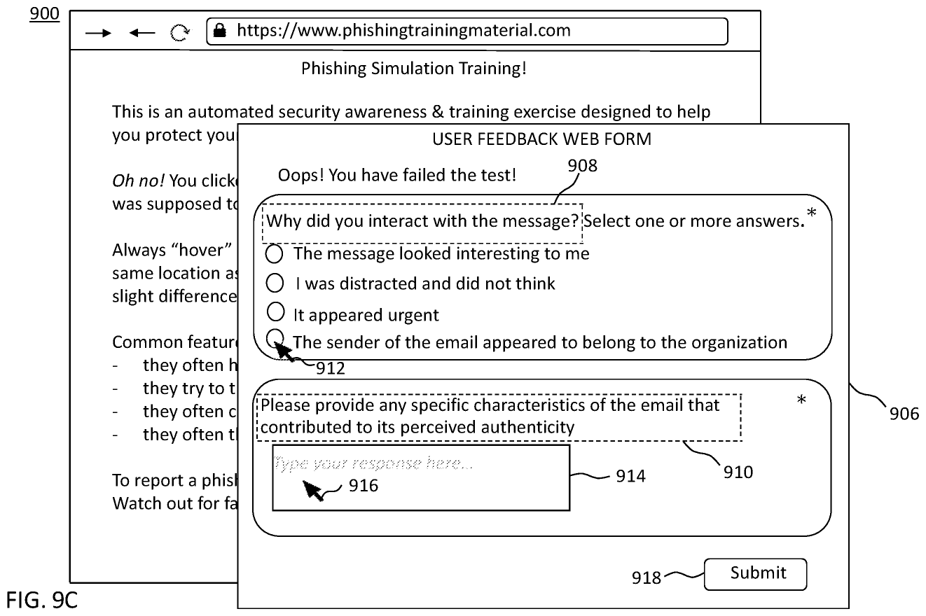

FIG. 9A illustrates example 900 of simulated phishing communication 902 (an email) received by a user, according to some embodiments.

In the example of FIG. 9A, simulated phishing communication 902 with subject “Pension Benefits” is shown. Simulated phishing communication 902 includes a message “The pension benefits plan period ends this Friday—select your benefits now by clicking on this link!”. The urgency in tone of the message may entice the user to interact with it. In an example, the user may interact with simulated phishing communication 902 by clicking on the link. In an example, when the user clicks on the link in simulated phishing communication 902, the user may be traversed to landing page 904 (shown in FIG. 9B) for receiving security awareness training. In an example, landing page 904 may alert the user that the user has failed a simulated phishing test and provide general or specific learning materials to the user. FIG. 9B illustrates an example of landing page 904 that the user is traversed to in response to interacting with simulated phishing communication 902, according to some embodiments. FIG. 9B is a continuation of FIG. 9A.

In examples, the user feedback may be gathered by a user feedback web form that may be presented automatically to the user during the security awareness training. FIG. 9C illustrates an example of user feedback web form 906 that is presented to the user during the security awareness training, according to some embodiments. FIG. 9C is a continuation of FIG. 9B.

In the example shown in FIG. 9C, user feedback web form 906 includes two user feedback questions 908, 910. User feedback questions 908 reads “Why did you interact with the message?” In examples, user feedback question 908 may be accompanied by one or more responses (the example in FIG. 9C includes four responses) from which a user may select, the four responses to be presented as candidate answers to user feedback question 908. In the example of FIG. 9C, the four responses include “The message looked interesting to me”, “I was distracted and did not think”, “It appeared urgent”, and “The sender of the email appeared to belong to the organization”. In an example, the user may select “The sender of the email appeared to belong to the organization” (for example, using mouse pointer 912) in response to the user feedback question 908. The user's response may be recorded as the user feedback. Further, user feedback question 910 reads “Please provide any specific characteristics of the email that contributed to its perceived authenticity.” In examples, user feedback question 910 may solicit freeform response from the user. In an example, text box 914 for a written answer may be provided to the user. In an example, the user may input in text box 914 (for example, using mouse pointer 916 and input devices such as a keyboard or touch screen display) that the user interacted with simulated phishing communication 902 because of use of a similar color theme to that of the trusted organization, or its similarity to previous authentic emails received from the organization. Further, the user may submit the response by clicking on submit button 918.

Referring again to FIG. 2, according to an implementation, user feedback categorization engine 232 may categorize the user feedback into one or more categories of a plurality of categories. In an implementation, user feedback categorization engine 232 may gather user feedback from multiple users across multiple simulated phishing campaigns or simulated phishing communications. In an implementation, user feedback categorization engine 232 may sort the user feedback into categories. In an example, the plurality of categories may include a category for responses relating to source authenticity/impersonation (for example, “I thought it was from a trusted source”), urgency (for example, “It was related to a critical project of mine”), familiarity (for example, “It resembled an email that I have received before”), interest (for example, “It was related to an interest or hobby of mine”), and other categories.

In an implementation, user feedback categorization engine 232 may categorize the user feedback based at least on one or more attributes of the one or more users from whom the user feedback was requested. Examples of one or more attributes of a user include, but are not limited to, the user's department or job role, seniority, completion of previously administered security awareness training, performance during previously administered security awareness training, history of involvement in security incidents, security risk score, and/or others. In examples, categorization of the user feedback may be performed for user feedback pertaining to a single user. In an example, the user feedback may be gathered over a period of time and after the user's interaction with one or more simulated phishing communications. In some examples, user feedback categorization engine 232 may perform categorization for the user feedback of multiple users and groups of users.

According to an implementation, user feedback analytics engine 234 may collate the categorized feedback into one or more classifications of a plurality of classifications. In examples, user feedback analytics engine 234 may collate the categorized feedback into the one or more classifications based at least on the one or more attributes of the one or more users. In an implementation, user feedback analytics engine 234 may collate the categories of user feedback according to attributes of the users such as “Senior Employee” or “Belonging to Engineering Department” into one or more classifications. In examples, user feedback analytics engine 234 may generate a classification for “Senior Employee; Reason: familiarity”, “Senior Employee; Reason: Familiarity or Urgency”, or “Belonging to Engineering Department; Reason: Distracted” etc.

In some embodiments, user feedback analytics engine 234 may identify, from the feedback, one or more trends in the one or more reasons for the one or more users to interact with the one or more simulated phishing communications. In examples, user feedback analytics engine 234 may identify trends in the frequencies of occurrence of the reasons provided in the user feedback, and the similarities and differences between the user feedback of the users within an organization, within a department, amongst users of a specific seniority level or risk score, and/or according to any of the above defined categories. In an implementation, user feedback analytics engine 234 may identify trends and/or correlations in the user feedback in relation to a phish prone percentage or security maturity score. In an example, a phish prone percentage of a user may be a metric representing a proportion of simulated phishing attacks or real phishing attacks that the user has failed out of a total of simulated phishing attacks or real phishing attacks the user has received. In some examples, a user's phish prone percentage may reflect the security knowledge of the user. In examples, a security maturity score is a quantitative numerical representation of a user's performance within security awareness and training platform 202. In an example, a security maturity score represents a combination of metrics including, for example, phish prone percentage, interaction with phishing communications, previously completed security awareness training, risk score, or a combination or aggregation of more than one of these metrics. A security maturity score may be a numerical value within a set range (e.g., 0 to 1, −10 to 10, 1 to 5, etc.).

According to an implementation, by classifying and identifying trends in the user feedback, user feedback analytics engine 234 is enabled to identify one or more insights into why a specific one or more users interact in one or more specific ways to the one or more simulated phishing communications. In examples, user feedback analytics engine 234 may identify that users belonging to the engineering department of an organization frequently interact with simulated phishing communications that they perceive to be sent from their manager (i.e., a trusted source). In the example, user feedback analytics engine 234 may identify that each user provided additional feedback that specified that the manager in question had communicated a promotion opportunity in a recent meeting. Accordingly, user feedback analytics engine 234 may develop insights regarding the susceptibility of users to simulated phishing communications in relation to promotion opportunities.

In an implementation, user feedback analytics engine 234 may create a benchmark between the one or more users and another one or more users based on the user feedback. In examples, user feedback analytics engine 234 may establish benchmarks regarding user susceptibility and interactions to simulated phishing communications as compared to other users or groups of users within an organization or across several organizations in a related market sector to the organization. According to an implementation, user feedback analytics engine 234 may establish benchmarks for groups of users, departments of users, and the whole organization. The benchmarks may allow the assessment of a given user's, group of users,′ departments of users,′ and/or organization's responses in relation to the benchmark.

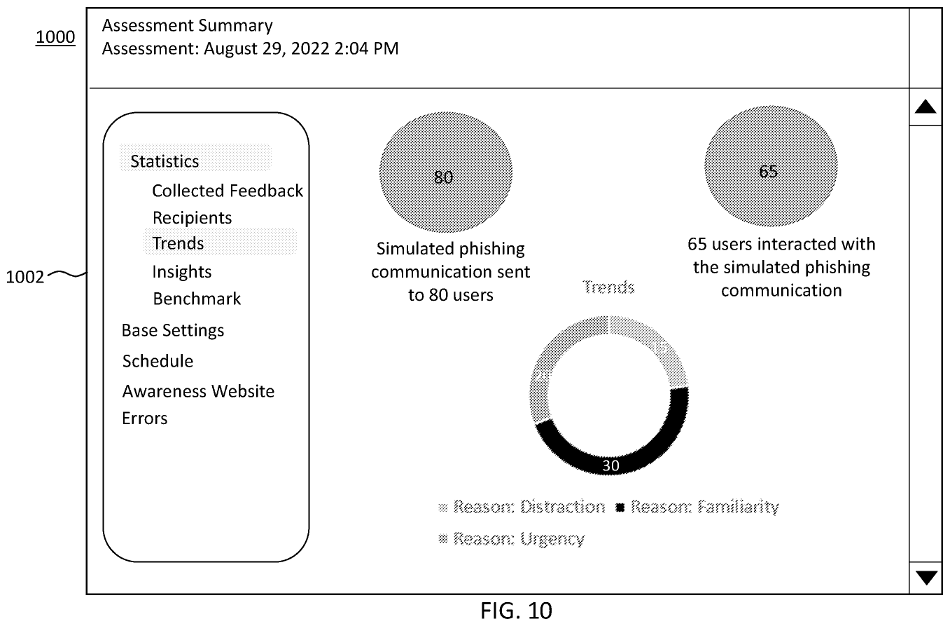

FIG. 10 illustrates example 1000 of interface 1002 presented to a system administrator to view trends in the reasons for the users to interact with the simulated phishing communication, according to some embodiments. In the example shown in FIG. 10, a simulated phishing communication was sent to 80 users, and 65 users out of the 80 users interacted with the simulated phishing communication. Further, feedback was sought from the 65 users to know the reasons as to why the users interacted with the simulated phishing communication. Furthermore, trends in the one or more reasons for the users to interact with the simulated phishing communication were identified. In the example of FIG. 10, it is shown that 15 users interacted with the simulated phishing communication as they were distracted and did not think, 30 users interacted with the simulated phishing communication as the simulated phishing communication appeared familiar, and 20 users interacted with the simulated phishing communication as the simulated phishing communication appeared urgent.

According to an implementation, template association engine 236 may associate metadata identified based on the user feedback with one or more simulated phishing templates. In an implementation, template association engine 236 may associate insights developed by the user feedback analytics engine 234 to simulated phishing templates for the purpose of aiding a system administrator and/or recommendation engine 238 in selecting the most effective simulated phishing template for a simulated phishing campaign targeting a given user or group of users.

In an implementation, template association engine 236 may tag or associate a simulated phishing template with one or more common reasons for user interaction, as derived from user feedback. In examples, this results in creation of template selection metadata sourced from a population of users that have user feedback on why they interacted with a simulated phishing communication. In examples, template association engine 236 may use data gathered by or generated by user feedback analytics engine 234. In an example, template association engine 236 may identify top three reasons that users interact with a simulated phishing template and may tag or associate as metadata with the simulated phishing template in question.

According to an implementation, recommendation engine 238 or a system administrator may create one or more simulated phishing templates using the user feedback. Further, recommendation engine 238 or the system administrator may create a second one or more simulated phishing communications using the one or more simulated phishing templates. According to an implementation, recommendation engine 238 or the system administrator may select one or more simulated phishing templates based at least on the metadata and common tags. Recommendation engine 238 or the system administrator may then create or select the second one or more simulated phishing communications using the one or more simulated phishing templates.

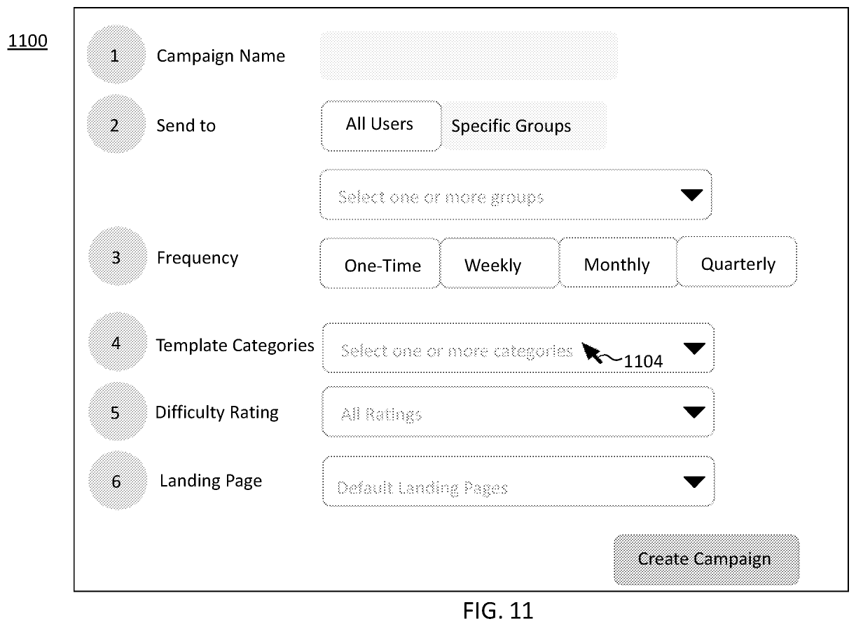

FIG. 11 illustrates example 1100 of selecting one or more simulated phishing templates by a system administrator, according to some embodiments.

In the example of FIG. 11, while configuring a simulated phishing campaign, a system administrator may select one or more simulated phishing templates on which one or more simulated phishing communications will be based and sent to users. In an example, the system administrator may select one or more simulated phishing templates (for example, using mouse pointer 1104). The simulated phishing templates may be grouped templates that may have common tags or metadata as other simulated phishing templates that the users or group of users have previously failed.

According to an implementation, recommendation engine 238 may include an artificial intelligence (AI) algorithm to select a simulated phishing template based on a specific model and other information such an industry of an organization of the user, a geographic region of the user, a demographic of the user or an organizational level of the user. In some examples, recommendation engine 238 may select the simulated phishing template based on attributes or a profile of the user, the history of the user with respect to simulated phishing campaigns and based on the results of executed simulated phishing campaigns. In an implementation, recommendation engine 238 may dynamically modify the content of simulated phishing communications in response to the application of the model. The simulated phishing template may also be customized by recommendation engine 238 based on the profile of the user or the classification group of the user.

In an implementation, recommendation engine 238 or a system administrator may initiate a second simulated phishing campaign towards users who have previously failed a first simulated phishing campaign. In examples, the system administrator may use simulated phishing templates that are associated with the user feedback indicating the same common reasons for interacting with the simulated phishing communication that caused the users to fail the first simulated phishing campaign. In an implementation, recommendation engine 238 may communicate the second one or more simulated phishing communications to the one or more users based at least on one of the categorized feedback or the one or more classifications.

Accordingly, users may be sent simulated phishing communications based upon simulated phishing templates that evaluate their behaviors and security awareness based upon their user feedback on interactions with previous simulated phishing communications (based on the previous simulated phishing templates). In other examples, the users may be sent remedial training related to the reasons for their interaction with the simulated phishing communications and as reported by user feedback. Further, after the users complete the remedial training, the users may be sent other simulated phishing communications based on simulated phishing templates specific to the category or classification of the users' responses to evaluate their retention of the training and to therefore validate the effectiveness of the training.

According to aspects of the present disclosure, user feedback about why users interacted with simulated phishing communications can be used to identify where users lack security awareness in an organization, and to enable targeted responses appropriate to the users' behaviors. In examples, security awareness training that is administered after a security administrator has received the user feedback can focus on specific areas related to the feedback that the users provided on why they interacted with the simulated phishing communications. Further, when selecting a simulated phishing template for a future simulated phishing campaign, it is beneficial to evaluate whether the targeted training has been effective. It is therefore advantageous to know simulated phishing templates which are associated with user feedback indicating the same common reasons for interacting with the simulated phishing communication.

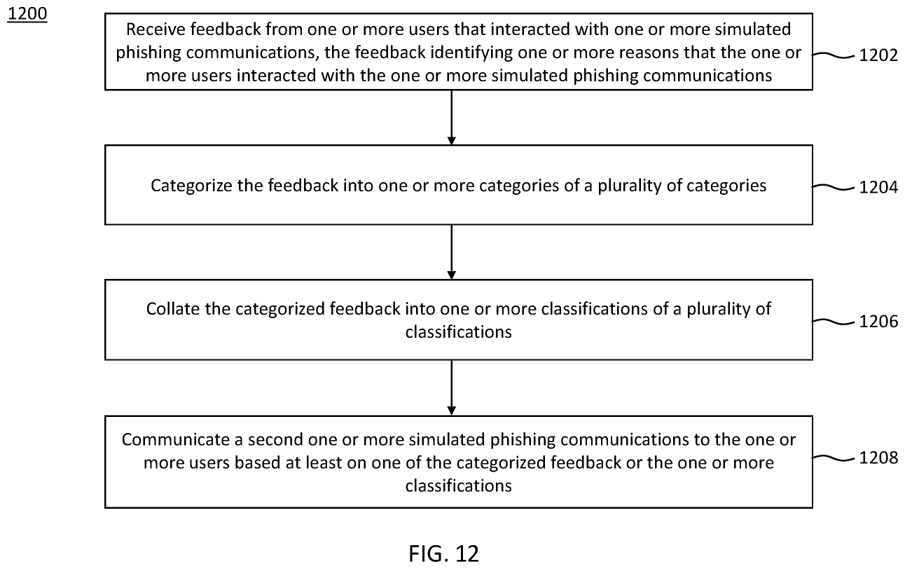

FIG. 12 depicts flowchart 1200 for communicating a second one or more simulated phishing communications to one or more users, according to some embodiments.

In a brief overview of an implementation of flowchart 1200, at step 1202, feedback from one or more users that interacted with one or more simulated phishing communications may be received. In examples, the feedback identifies one or more reasons that the one or more users interacted with the one or more simulated phishing communications. At step 1204, the feedback is categorized into one or more categories of a plurality of categories. At step 1206, the categorized feedback is collated into one or more classifications of a plurality of classifications. At step 1208, a second one or more simulated phishing communications are communicated to the one or more users based at least on one of the categorized feedback or the one or more classifications.

Step 1202 includes receiving feedback from one or more users that interacted with one or more simulated phishing communications, the feedback identifying one or more reasons that the one or more users interacted with the one or more simulated phishing communications. According to an implementation, user feedback requestor 230 may be configured to receive feedback from one or more users that interacted with one or more simulated phishing communications, the feedback identifying one or more reasons that the one or more users interacted with the one or more simulated phishing communications. In an implementation, user feedback requestor 230 may receive the feedback selected by the one or more users from a predetermined set of responses.

Step 1204 includes categorizing the feedback into one or more categories of a plurality of categories. According to an implementation, user feedback categorization engine 232 may be configured to categorize the feedback into one or more categories of the plurality of categories. In an implementation, user feedback categorization engine 232 may cause a prompt for the feedback from the one or more users responsive to the one or more users interacting with the one or more simulated phishing communications.

Step 1206 includes collating the categorized feedback into one or more classifications of a plurality of classifications. According to an implementation, user feedback analytics engine 234 may be configured to collate the categorized feedback into one or more classifications of the plurality of classifications based on one or more attributes of the one or more users.

According to an implementation, one or more trends in the one or more reasons for the one or more users to interact with the one or more simulated phishing communications may be identified from the feedback. Further, one or more insights into why a specific one or more users interact in one or more specific ways to the one or more simulated phishing communications may be identified from the feedback. In some embodiments, a benchmark may be created between the one or more users and another one or more users based on the feedback. In an implementation, metadata identified based on the feedback may be associated with the one or more simulated phishing templates.

Step 1208 includes communicating a second one or more simulated phishing communications to the one or more users based at least on one of the categorized feedback or the one or more classifications. According to an implementation, recommendation engine 238 may be configured to interact with simulated phishing campaign manager 220 to cause message generator 222 to create the second one or more simulated phishing communications and communicate the second one or more simulated phishing communications to the one or more users based at least on one of the categorized feedback or the one or more classifications. In an implementation, one or more simulated phishing templates specific based at least on the metadata may be used for selecting the second one or more simulated phishing communications using the one or more simulated phishing templates.

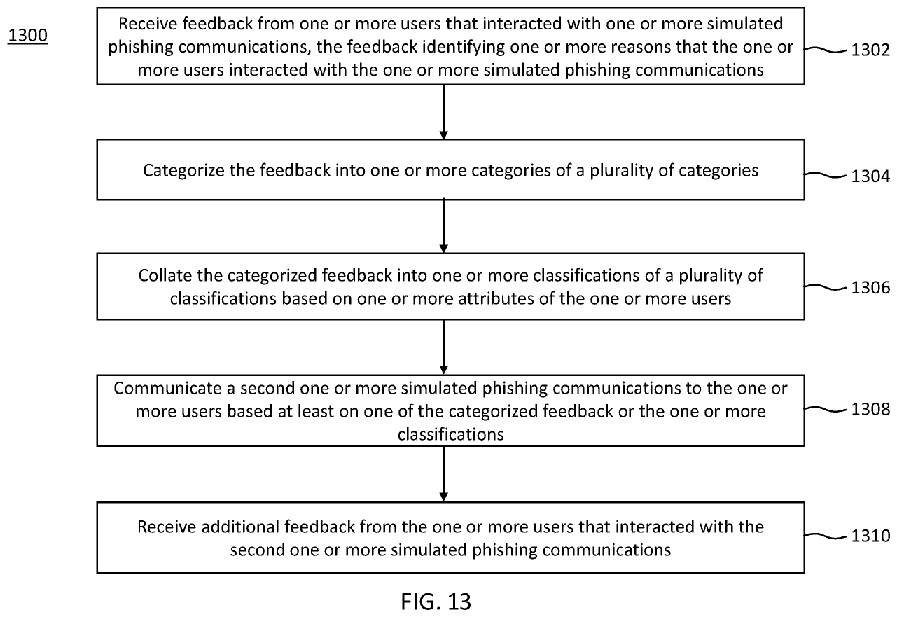

FIG. 13 depicts flowchart 1300 for receiving additional feedback from the one or more users that interacted with second one or more simulated phishing communications, according to some embodiments.

In a brief overview of an implementation of flowchart 1300, at step 1302, feedback from one or more users that interacted with one or more simulated phishing communications may be received. The feedback identifies one or more reasons that the one or more users interacted with the one or more simulated phishing communications. At step 1304, the feedback is categorized into one or more categories of a plurality of categories. At step 1306, the categorized feedback is collated into one or more classifications of a plurality of classifications based on one or more attributes of the one or more users. At step 1308, a second one or more simulated phishing communications are communicated to the one or more users based at least on one of the categorized feedback or the one or more classifications. At step 1310, additional feedback is received from the one or more users that interacted with the second one or more simulated phishing communications.

Step 1302 includes receiving feedback from one or more users that interacted with one or more simulated phishing communications, the feedback identifying one or more reasons that the one or more users interacted with the one or more simulated phishing communications. According to an implementation, user feedback requestor 230 may be configured to receive feedback from one or more users that interacted with one or more simulated phishing communications, the feedback identifying one or more reasons that the one or more users interacted with the one or more simulated phishing communications. In an implementation, user feedback requestor 230 may receive the feedback selected by the one or more users from a predetermined set of responses.

Step 1304 includes categorizing the feedback into one or more categories of a plurality of categories. According to an implementation, user feedback categorization engine 232 may be configured to categorize the feedback into one or more categories of the plurality of categories. In an implementation, user feedback categorization engine 232 may cause a prompt for the feedback from the one or more users responsive to the one or more users interacting with the one or more simulated phishing communications.

Step 1306 includes collating the categorized feedback into one or more classifications of a plurality of classifications based on one or more attributes of the one or more users. According to an implementation, user feedback analytics engine 234 may be configured to collate the categorized feedback into one or more classifications of the plurality of classifications based on one or more attributes of the one or more users. According to an implementation, user feedback analytics engine 234 may be configured to collate the categorized feedback into one or more classifications of the plurality of classifications based at least on one or more attributes of the one or more users.

Step 1308 includes communicating a second one or more simulated phishing communications to the one or more users based at least on one of the categorized feedback or the one or more classifications. According to an implementation, recommendation engine 238 may be configured to communicate the second one or more simulated phishing communications to the one or more users based at least on one of the categorized feedback or the one or more classifications. In an implementation, the second one or more simulated phishing communications may be created using the feedback for the one or more simulated phishing templates.

Step 1310 includes receiving additional feedback from the one or more users that interacted with the second one or more simulated phishing communications. According to an implementation, user feedback requestor 230 may be configured to receive the additional feedback from the one or more users that interacted with the second one or more simulated phishing communications.

The systems described above may provide multiple ones of any or each of those components and these components may be provided on either a standalone machine or, in some embodiments, on multiple machines in a distributed system. The systems and methods described above may be implemented as a method, apparatus or article of manufacture using programming and/or engineering techniques to produce software, firmware, hardware, or any combination thereof. In addition, the systems and methods described above may be provided as one or more computer-readable programs embodied on or in one or more articles of manufacture. The term “article of manufacture” as used herein is intended to encompass code or logic accessible from and embedded in one or more computer-readable devices, firmware, programmable logic, memory devices (e.g., EEPROMs, ROMs, PROMS, RAMS, SRAMs, etc.), hardware (e.g., integrated circuit chip, Field Programmable Gate Array (FPGA), Application Specific Integrated Circuit (ASIC), etc.), electronic devices, a computer readable non-volatile storage unit (e.g., CD-ROM, floppy disk, hard disk drive, etc.). The article of manufacture may be accessible from a file server providing access to the computer-readable programs via a network transmission line, wireless transmission media, signals propagating through space, radio waves, infrared signals, etc. The article of manufacture may be a flash memory card or a magnetic tape. The article of manufacture includes hardware logic as well as software or programmable code embedded in a computer readable medium that is executed by a processor. In general, the computer-readable programs may be implemented in any programming language, such as LISP, PERL, C, C++, C#, PROLOG, or in any byte code language such as JAVA. The software programs may be stored on or in one or more articles of manufacture as object code.

While various embodiments of the methods and systems have been described, these embodiments are illustrative and in no way limit the scope of the described methods or systems. Those having skill in the relevant art can effect changes to form and details of the described methods and systems without departing from the broadest scope of the described methods and systems. Thus, the scope of the methods and systems described herein should not be limited by any of the illustrative embodiments and should be defined in accordance with the accompanying claims and their equivalents.

What is claimed is:

1. A method comprising:
receiving, by one or more servers, feedback from one or more users that interacted with one or more simulated phishing communications, the feedback identifying one or more reasons that the one or more users interacted with the one or more simulated phishing communications;
categorizing, by the one or more servers, the feedback into one or more categories of a plurality of categories;
collating, by the one or more servers, the categorized feedback into one or more classifications of a plurality of classifications; and
communicating, by the one or more servers, a second one or more simulated phishing communications to the one or more users based at least on one of the categorized feedback or the one or more classifications.

2. The method of claim 1, further comprising receiving, by the one or more servers, the feedback selected by the one or more users from a predetermined set of responses.

3. The method of claim 1, further comprising causing, by the one or more servers, a prompt for the feedback from the one or more users responsive to the one or more users interacting with the one or more simulated phishing communications.

4. The method of claim 1, further comprising collating, by the one or more servers, the feedback into the one or more classifications based at least on one or more attributes of the one or more users.

5. The method of claim 1, further comprising identifying, by the one or more servers from the feedback, one or more trends in the one or more reasons for the one or more users to interact with the one or more simulated phishing communications.

6. The method of claim 1, further comprising identifying, by the one or more servers from the feedback, one or more insights into why a specific one or more users interact in one or more specific ways to the one or more simulated phishing communications.

7. The method of claim 1, further comprising creating, by the one or more servers, a benchmark between the one or more users and another one or more users based on the feedback.

8. The method of claim 1, further comprising associating, by the one or more servers, with the one or more simulated phishing templates metadata identified based on the feedback.

9. The method of claim 8, further comprising selecting, by the one or more servers, one or more simulated phishing templates specific based at least on the metadata, the second one or more simulated phishing communications using the one or more simulated phishing templates.

10. The method of claim 1, further comprising using, by the one or more servers, the feedback to create one or more simulated phishing templates, the second one or more simulated phishing communications using the one or more simulated phishing templates.

11. The method of claim 1, further comprising receiving, by the one or more servers, additional feedback from the one or more users responsive to security awareness training provided to the one or more users.

12. A system comprising:
one or more server configured to:
receive feedback from one or more users that interacted with one or more simulated phishing communications, the feedback identifying one or more reasons that the one or more users interacted with the one or more simulated phishing communications;
categorize the feedback into one or more categories of a plurality of categories;
collate the categorized feedback into one or more classifications of a plurality of classifications; and
communicate a second one or more simulated phishing communications to the one or more users based at least on one of the categorized feedback or the one or more classifications.

13. The system of claim 12, wherein the one or more servers are further configured to receive the feedback selected by the one or more users from a predetermined set of responses.

14. The system of claim 12, wherein the one or more servers are further configured to cause a prompt for the feedback from the one or more users responsive to the one or more users interacting with the one or more simulated phishing communications.

15. The system of claim 12, wherein the one or more servers are further configured to collate the feedback into the one or more classifications based at least on one or more attributes of the one or more users.

16. The system of claim 12, wherein the one or more servers are further configured to identify, from the feedback, one or more trends in the one or more reasons for the one or more users to interact with the one or more simulated phishing communications.

17. The system of claim 12, wherein the one or more servers are further configured to identify, from the feedback, one or more insights into why a specific one or more users interact in one or more specific ways to the one or more simulated phishing communications.

18. The system of claim 12, wherein the one or more servers are further configured to create a benchmark between the one or more users and another one or more users based on the feedback.

19. The system of claim 12, wherein the one or more servers are further configured to associate with the one or more simulated phishing templates metadata identified based on the feedback.

20. The system of claim 19, wherein the one or more servers are further configured to select one or more simulated phishing templates specific based at least on the metadata, the second one or more simulated phishing communications using the one or more simulated phishing templates.

21. The system of claim 12, wherein the one or more servers are further configured to use the feedback to create one or more simulated phishing templates, the second one or more simulated phishing communications using the one or more simulated phishing templates.

22. The system of claim 12, wherein the one or more servers are further configured to receive additional feedback from the one or more users responsive to security awareness training provided to the one or more users.
